(19) United States
(12) Patent Application Publication
(10) Pub. No.: US 2012/0002848 A1
(43) Pub. Date: Jan. 5, 2012

(54) METHOD OF ASSESSING PEOPLE'S SELF-PRESENTATION AND ACTIONS TO EVALUATE PERSONALITY TYPE, BEHAVIORAL TENDENCIES, CREDIBILITY, MOTIVATIONS AND OTHER INSIGHTS THROUGH FACIAL MUSCLE ACTIVITY AND EXPRESSIONS

(76) Inventor: Daniel A. Hill, St. Paul, MN (US)

(21) Appl. No.: 13/099,040

(22) Filed: May 2, 2011

Related U.S. Application Data
(63) Continuation-in-part of application No. 12/762,076, filed on Apr. 16, 2010.
(60) Provisional application No. 61/169,806, filed on Apr. 16, 2009.

(51) Int. Cl. G06K 9/00

(52) U.S. Cl. 382/118

(57) ABSTRACT

A method of assessing an individual through facial muscle activity and expressions includes receiving a visual recording stored on a computer-readable medium of an individual's non-verbal responses to a stimulus, the non-verbal response comprising facial expressions of the individual. The recording is accessed to automatically detect and record expressional repositioning of each of a plurality of selected facial features by conducting a computerized comparison of the facial position of each selected facial feature through sequential facial images. The contemporaneously detected and recorded expressional repositionings are automatically coded to an action unit, a combination of action units, and/or at least one emotion. The action unit, combination of action units, and/or at least one emotion are analyzed to assess one or more characteristics of the individual to develop a profile of the individual's personality in relation to the objective for which the individual is being assessed.

### CROSS REFERENCE TO RELATED APPLICATION

The present application is a continuation-in-part of U.S. patent application Ser. No. 12/762,076, filed on Apr. 16, 2010, entitled “Method of Assessing People's Self Presentation and Actions to Evaluate Personality Type, Behavioral Tendencies, Credibility, Motivations and Other Insights Through Facial Muscle Activity and Expressions,” which claims priority to U.S. Provisional Patent Application No. 61/169,806, filed on Apr. 16, 2009, entitled “Method of Assessing People's Self Presentation and Actions to Evaluate Personality Type, Behavioral Tendencies, Credibility, Motivations and Other Insights Through Facial Muscle Activity and Expressions,” each of which the entire contents thereof are hereby incorporated by reference herein in their entirety.

### FIELD OF THE INVENTION

The present disclosure relates generally to methods of evaluating people's personality type, behavioral tendencies, credibility, motivations, and other such insights. More particularly, the present disclosure relates to methods of evaluating people's non-verbal language to gain a better understanding of their personality type, behavioral tendencies, credibility, motivations, and other such insights related to applications including, but not limited to, personnel hiring, career development, training, interne dating, and the analysis of people involved in law suits as witnesses or in actual or mock/shadow juries.

Additional applications include, but are not limited to, both 1) the appearances of people on television or internet/mobile device programming, such as showing overall or specific, such as but not limited to second-by-second, facial coding results and/or traits-related results for politicians, athletes, contestants in reality programs, subjects of investigative journalism, or other newsmakers, etc.; and 2) target market segmentation and resulting strategies, for among other purposes, the identification or “tagging” of television programming that might be optimal for a given sponsor's television spots, based on evaluating people's non-verbal language to gain a better understanding of their personality types, behavioral tendencies, and motivations as well as buyer attitudes, decision-making styles, receptivity to advertising styles/content, offer usage rate, and/or degree of loyalty.

### BACKGROUND OF THE INVENTION

The reality is that people lie to themselves, and to others. Indeed, it's been estimated that the average person lies three times in every ten minutes of conversation. The problem that this lack of inherent honesty poses for those trying to evaluate the skills, nature, knowledge, and veracity of another person therefore becomes of fundamental concern to a host of parties, ranging from employers to people evaluating the self-presentation of potential romantic partners or those testifying or otherwise involved in legal matters. Moreover, even when lying is not the issue, understanding the emotional dimension that breakthroughs in brain science have recently documented as crucial to people's decision-making and behavior is difficult, at best, to grasp through verbal input alone. That's because human beings verbal abilities reside in the conscious, rational part of the brain, whereas the older, more subconscious sensory and emotional parts of the brain have “first mover” advantage in people's thought process and therefore often play a dominate role in how people act. Because people don't think their feelings, they feel them, the general need arises to find a solution to the difficulties inherent in relying on the evaluation of words alone to convey meaning and motives in a reliable, insightful manner.

For instance, consider the situation of a company trying to choose which worker to hire for a new job opening. Research indicates that the selection process among job applicants has decidedly checkered results. Even the best measures, like a general mental ability test, a work sample test, and/or integrity tests have been found to be generally no more than 40% to 50% accurate in predicting a choice that proves to work out well once the person gets hired. Considering that turn-over caused by poor personnel selection can cost a company 2 to 7 times an employee's annual salary once lost training costs and other factors are taken into account, clearly companies and all organizations in general would like to improve their odds of choosing suitable personnel. Indeed, this situation becomes even more severe in the case of drafting or trading for professional athletes, whose often astronomical salaries dictate both competitive success and the financial viability of profitability of major league clubs.

Moreover, even if the person hired proves to be adequate for the position in functional terms, with a bias toward cognitive ability, the reality is that advances in brain science as well as ever more sophisticated approaches to evaluating, training, and promoting personnel for new, often supervisory roles within a company now look to evaluating emotional intelligence (EQ) and potential as well. After all, whether it involves supervising workers or interacting with vendors, business partners, or outside parties like the press, investors, and regulators, people skills matter. Therefore, understanding the emotional profile, i.e., the emotional tendencies, and emotionally-fueled attitudes and values of people ranging from in-field supervisors to senior executives, can be of benefit in determining employee's career paths, needs for training, and the like. Unfortunately, at present, instruments like interviews or questionnaires rely on assessing the emotional profile and other qualities of an individual through rationally oriented, cognitively filtered means that emphasize formulating thoughts in written or oral form.

Another sample instance where relying on written or oral input alone to evaluate another person's personality type, behavioral tendencies, credibility, motivations, and other such insights can prove to be problematic is in trying to assess potential romantic partners. Traditionally, people meeting one another did so in person or through mutual contacts like family members or friends. But in recent years, changes in society ranging from the frequency of moves to new locations, the anonymity of modern life, and the emergence of the internet have combined to make internet dating services, matchmaker dating services, and the like, a prevalent set of options for people looking to enrich their personal life through meeting others that they might date, marry, or cultivate as special friends. At present, most of these dating services that have arisen hope to match people based on their submission of answers to build a profile that purports to identify their interests, habits, personality type, emotional make-up, and so forth. Whether that input is reliable, however, remains a serious issue as clearly people can be readily inspired to enhance their strengths and mitigate blemishes that might stand in the way of their securing an unsuspecting partner.

Yet another sample instance where the current reliance on verbal or written self-presentation alone poses a problem involves trying to assess people's self-presentation in courtroom settings. At present, lawyers and their clients rely first and foremost on the oral and written statements of witnesses, defendants, prospective jury members, and members of a mock or shadow jury that a law firm may use to test its lines of argumentation in order to assess the relevancy, credibility of people's testimony, or view points. At times, lawyers may certainly seek to supplement those oral or written statements with attempts to read the “body language” of people. But given research that indicates that even the best detectors of lying—secret service agents, followed by psychologists—are at no better than chance levels of detecting deception, certainly a means of evaluating the veracity of people's statements, knowledge, biases, etc., would be hugely beneficial in guarding against errors in strategies formulated based on the slippery medium of language alone.

Related to human-interest video, but taking it more broadly to incorporate instances where television programming and internet or mobile device content might become both more informative and entertaining is to consider the array of instances where people and their personality, veracity, etc., are really a crucial element of programming content. For instance, when politicians are shown in a presidential debate, it could be helpful and of great interest to viewers to be able to simultaneously see a chart that reveals the emotions the candidates are revealing during the course of the debate, even on a real-time, such as second-by-second, basis. Other examples include people testifying before the U.S. Congress, athletes and coaches shown on sports programming, people who are participating in reality shows, people who are the subject of investigative journalism, and the like. In these instances, to know what the people are emoting and being able to put that into the context of the program content can provide a distinct benefit over and above how television programming currently operates. In addition, it could be beneficial if such emoting information could be translated into providing traits profiles, and related analysis, for the people shown in such programming, including their emoting patterns.

Furthermore, when it comes to people inherently lying or otherwise failing to represent accurately who they are and what that might mean in terms of behavioral tendencies, motivations, and receptivity to marketing, it isn't only potential employers, lawyers, judges, romantic partners, who suffer from insufficient or inaccurate personality assessments. Traditionally, marketing strategy has depended on demographic measures to segment the target market in order to better identify, and understand, the consumers to be marketed to, and how best to conduct the marketing campaigns. However, more and more evidence is arising that conventional, demographic segmentation doesn't work very well when it comes to predicting consumer purchase behavior based on segments derived from variables like age, gender, race, education, income, marital status, geography, and occupation.

For instance, in the November 2009 issue of Sales/Marketing Management, the conclusion was offered that, in general, “evidence indicates that demographic measures, outside of education, are not an accurate predictor of behavior.” Moreover, at the 2011 Advertising Research Federation's annual conference, Dave Poltrack, chief researcher for CBS, reported that based on analysis done by Nielsen, he had now concluded that using demographics to target commercials is “essentially invalid, resulting in a misallocation of television advertising investments.” Advertising Age, on-line edition, Mar. 24, 2011.

Alternatives or supplements to conventional, demographic segmentation have been based on efforts to capture so-called “psychographics.” Psychographics typically involve either trying to deduce a person's interests, values, and lifestyles through surrogates like the television shows a person watches and the magazines they subscribe to, and/or based on survey ratings. Neither approach solves the problem the various embodiments of the present disclosure address, however, because they're either merely external manifestations of who the person is or, again, fall back on people reliably being able to report on subject matter that is inherently intimate, subjective, and often beyond a person's conscious awareness. Attempts within the psychographics realm to capture the personality characteristics of consumers segmented into different groups has led to marketers at times resorting to flimsy constructs like “explorer” or “mainstreamer,” for example, in attempts to depict who they are trying to connect with through advertising campaigns.

Given the shortcomings of demographic based segmentation and the inherent weaknesses of psychographic based segmentation as a supplement to flawed demographic segmentation data, a need exists for ways that companies can make their messaging seen and heard by the people most likely to purchase their offers. Companies want to focus their marketing efforts and dollars on those likely to generate a profitable return. But to do so, they must understand how the target market truly feels, what they want, and how they go about their day to day lives in ways that neither demographics or psychographics can deliver on.

Fortunately, standardized methods exist to assess an individual's personality. For example, at present, job applicants whose personality is being assessed are most likely to be given a written exam that reflects either the Myers-Brigg 4-factor model of personality type or else the now more critically acclaimed Big Five Factor model of personality type, sometimes known as McCrae and Costa, in honor of two of its most notable psychologist developers. The Big Five Factor model is described in Mathews, G., Deary, I., and Whiteman, M., Personality Traits, Cambridge University Press, Cambridge, U.K., (2003), Wiggins, J., editor, The Five-Factor Model of Personality, Guilford Press, New York City (1996), McCrae, R., Costa, P., Personality in Adulthood: A Five-Factor Theory Perspective, Guilford Press, New York City (2003), and specifically in relation to evaluating personnel, in Howard, P. and Howard, J., The Owner's Manual for Personality at Work, Bard Press, Austin, Tex. (2001), each of which is hereby incorporated by reference in its entirety herein. However, despite Howard's work in evaluating personnel, the reality is that the Big Five Model for personality types can also be applied to assessing a potential romantic partner among a range of other applicants, casting for movies, to determine a child's personality type to ensure a compatible tutor or best practices for educational purposes, which player to draft to join a team sport like the NBA or NFL, etc. The Big Five Factor model is sometimes referred to by the acronym of OCEAN because it rests on the conclusion that the traits of openness, conscientiousness, extraversion, agreeableness and neuroticism (or emotional stability) form the basis of people's personalities.

Additionally, a new field that blends psychology, neuro-biology and economics called Behavioral Economics has recently emerged that could prove useful. This field is premised on the belief, aided by breakthroughs in brain science, that people are predominantly emotional decision-makers. Eliciting answers to questions based on the key principles of Behavioral Economics, such as loss aversion, conformity, fairness bias, etc., provides the additional benefit of zeroing in on the emotional dimension of how personnel performs on the job, or how much a person in general is susceptible to the biases that this new field of economics zeroes in on, an area that the traditional, rational, cognitively filtered approaches to assessing personnel have generally either ignored or been unable to capture other than through written and verbal, cognitively filtered means. Prominent works in the field of Behavioral Economics include Wilkinson, N., An Introduction to Behavioral Economics, Palgrave, London, U.K. (2008), Ariely, D., Predictably Irrational: The Hidden Forces That Shape Our Decisions, HarperCollins, New York City (2008), and Thaler, R., Sunstein, C., Nudge: Improving Decisions about Health, Wealth, and Happiness, Yale University Press, New Haven, Conn. (2008), each of which is hereby incorporated by reference in its entirety herein.

As noted by Geoffrey Miller in Spent: Sex, Evolution, and Consumer Behavior and by Sam Gosling in Snoop: What Your Stuff Says, the Big Five Model provides a viable alternative. Indeed, Miller states: “Surprisingly, most marketers have no idea how well the Big 5 can predict consumer behavior. The Big 5 predicts attitudes, values, self-concepts, and motivations.”

The Big Five Model is based on research that has involved academic researchers, as well as researchers at the U.S. Air Force and the National Institutes of Health. Over a span of nearly 80 years now, and with ever increasing certainty, the Big 5 has emerged, in the words of Gosling, as “[b]y far the most extensively examined—and firmly established—system for grouping personality traits.”

There are numerous advantages to the Big Five Model. It predicts human behavior in diverse settings and situations. It is genetically heritable and stable across life span. The traits are also universal across cultures and each of the traits is statistically independent from the others. Moreover, in linking personality traits to lasting habits and reactions to specific stimuli, the Big Five Model provides a reliable, intimate reading of buyer attitudes and decision-making styles, receptivity to advertising styles and content, and aids in prediction of offer usage rates and degrees of loyalty based on the emotional context or aspects of a marketing effort.

Nevertheless, the use of the Big Five Model to achieve better segmentation is customarily based on securing self-reported ratings. In other words, participants are asked to rate themselves on a series of questions that will correlate and, ideally, reveal their scores or “profile” across the Big Five Traits. The difficulty, however, is that self-reporting is open to compromises and, hence, flawed data. For one thing, people may surmise that a given ratings question if answered honestly will confirm that they score high on the embarrassing trait of neuroticism. So they may not give an accurate answer. That's the “won't” say part of the dilemma. But, given advances in neurobiology that indicate that up to 98% of people's thought activity isn't fully conscious, e.g., isn't known to them, there's also a huge “can't” say risk of people not even accurately knowing themselves.

Whether in regard to Myers-Briggs, The Big Five Factor model, Behavioral Economics or some other such model for assessing personality type, the array of testing methods in practice all generally rely on tests with written self-assessment scoring, buttressed at times by additional assessments from individuals with presumably good, intimate knowledge of the person subject to testing, or third parties. Because of the susceptibility of self-reporting to willful or unconscious deception, a more reliable method is sought for capturing an understanding of how the person fits that particular model. To date, the few attempts to use psycho-physiological methods to gauge personality type and link it to the Big Five Model, for example, have involved other techniques like electroencephalography (EEG), heart rate, sweat gland activity or functional brain imaging. These approaches suffer from requiring the use of electrodes or other invasive monitors and also have not attempted more than typically one or two of the five trait dimensions that make up the Big Five Model, exploring traits like extraversion or at times neuroticism, without attempting to be comprehensive in finding psycho-physiological correlates for all of the five traits.

Thus, there exists a need in the art for a better way to assess non-verbal language to gain a better understanding of people's personality type, behavioral tendencies, credibility, motivations and other such insights. While the above instances by no means exhaust the range of issues the various embodiments of the present disclosure can be applied against, they do represent instructive instances where the study of facial muscle activity and expressions could address an outstanding problem. At the same time, opportunities are needed such as being able to evaluate the emotional content of human-interest video posted to the internet to evaluate its content more adroitly, or of being able to evaluate the emotional content of video of people shopping in a store in order to provide better customer service for them.

### BRIEF SUMMARY OF THE INVENTION

To overcome the “won't” and “can't” say pitfalls, the various embodiments of the present disclosure may utilize knowledge of people's emoting patterns as those patterns correspond, for example, to the Big Five Model. Put simply, facial coding results, by person, that take into account how people have rated themselves on the Big Five traits provides another means by which to determine, more directly over time, what traits pertain to people without asking them to self-rate or be rated by others who know them well. For instance, it can be deduced fairly reasonably that a person who exhibits an unusually high degree of anxiety will be a candidate for high neuroticism, and so forth. The various embodiments of the present disclosure may utilize emotion/trait correspondences between the Big Five and facial coding's core seven emotions of happiness, surprise, skepticism/contempt, anxiety, frustration, sadness, and disgust to understand people's personalities and, hence, likely behavior, so that they might be marketed to more effectively. Ancillary means of independently confirming a person's traits, such as through their internet usage habits or writing styles can be employed as secondary measures, to correlate and establish more confidence in the traits profiles deduced.

The present disclosure, in one embodiment, relates to a method of assessing an individual through facial muscle activity and expressions. The method can include receiving a visual recording stored on a computer-readable medium of an individual's non-verbal responses to a stimulus, the non-verbal response comprising facial expressions of the individual, so as to generate a chronological sequence of recorded verbal responses and corresponding facial images. The computer-readable medium can be accessed to automatically detect and record expressional repositioning of each of a plurality of selected facial features by conducting a computerized comparison of the facial position of each selected facial feature through sequential facial images. The contemporaneously detected and recorded expressional repositionings can be automatically coded to an action unit, a combination of action units, or other facial expression or facial expressions, and/or at least one emotion. The action unit, combination of action units, other facial expression or facial expressions, and/or at least one emotion can be analyzed to assess one or more characteristics of the individual to develop a profile of the individual's personality in relation to the objective for which the individual is being assessed.

The present disclosure, in another embodiment, relates to a method of assessing an individual through facial muscle activity and expressions. The method can include receiving a visual recording stored on a computer-readable medium of an individual's response to a stimulus, a first portion of the individual's response comprising facial expressions of the individual, so as to generate a chronological sequence of recorded facial images. The computer-readable medium can be accessed to automatically detect and record expressional repositioning of each of a plurality of selected facial features by conducting a computerized comparison of the facial position of each selected facial feature through sequential facial images. The contemporaneously detected and recorded expressional repositionings are automatically coded to an action unit, a combination of action units, or other facial expression or facial expressions, and/or at least one emotion. The action unit, combination of action units, or other facial expression or facial expressions, and/or at least one emotion may be analyzed against a second portion of the individual's response to the stimulus to assess one or more characteristics of the individual.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is a flow chart of showing a method according to one embodiment of the present disclosure.

FIG. 2A is a chart showing a correlation of traits to emotions according to one embodiment of the present disclosure. For example, the chart indicates which emotions, whether shown more often and strongly or less often and more weakly, pertain to each of the OCEAN traits. From that, in either an after-the-fact, analytical basis or potentially even in real-time based on availability or through observation, the determination of an individual's personality type might be reasonably secured.

FIG. 2B is a chart illustrating correlation ratings between four emotional responses and the Big Five personality traits according to one embodiment of the present disclosure.

FIG. 3 is a diagram showing the Big Five Factor model sample results according to one embodiment of the present disclosure.

FIG. 4 is a chart showing graphic representation of how facial muscle activity or expressions results, in alignment with biases that pertain to Behavioral Economics, can reveal the tendencies of a person or group of people to be susceptible to those behavioral vulnerabilities, according to one embodiment of the present disclosure. A norm might, for instance, reflect the degree to which people are emotionally susceptible to a given tendency, based on a formula of, for example, specific emotions they display most prominently in response to a given question, with the result showing whether they are above, below, or within a specified range of what people reveal emotionally in regards to that tendency.

FIG. 5 is an illustration of the location of various facial features/muscles which can be useful to detect emotions according to one embodiment of the present disclosure.

FIG. 6 is a diagram showing Engagement levels according to one embodiment of the present disclosure. For example, the diagram may indicate the amount of emoting, by action unit, based on duration or volume to indicate how motivated or engaged a person or people are by what they are saying/hearing/seeing/doing. When a plurality of subjects are involved, such as with a mock jury, then a percentage of the subjects who are emoting during the presentation of a particular topic or line or argumentation can also be used, as shown in FIG. 6.

FIG. 7 is a diagram showing overall emotion by type according to one embodiment of the present disclosure. For example, the diagram may indicate the percentage by which a person or group of people might be predominantly positive, neutral, or negative regarding what they might be saying/hearing/seeing/doing during a specific point in an interview, for instance, or over the duration of an interview, mock jury presentation, etc.

FIG. 8 is a chart showing an emotional profile according to one embodiment of the present disclosure. For example, the chart may indicate the specific emotions that a person or people are revealing in response to what they are saying/hearing/seeing/doing regarding a specific topic or scenario being enacted or line of argumentation.

FIG. 9 is a diagram showing an impact and appeal chart according to one embodiment of the present disclosure. For example, the chart may indicate the Impact and Appeal values, shown on a quadrant chart, to indicate by person, for example in a lineup of positive job hires, who emotes with the most Impact and/or Appeal to a particular question versus another, or on average for one person versus others.

FIG. 10 is a chart showing a second-by-second impact and appeal according to one embodiment of the present disclosure. For example, the chart may indicate the Impact and Appeal values, based on proprietary scoring weights for the action units shown by a person or group of people, to a statement, audio presentation, etc., to indicate at which points in the presentation people are emoting most and in what ways to reveal the relevancy and interest and type of response they have to the presentation being given.

FIG. 11 is a chart showing an emotional display in real time according to one embodiment of the present disclosure. For example, second-by-second charts that can show the precise intensity and valence of one person over the course of a set amount of time may be used. In addition, individual emotions can be identified when they happen.

FIG. 12 is an analyzed facial coding transcript according to one embodiment of the present disclosure. For example, the transcript may be coded to reveal the positive or negative valence or appeal of that person at that point in the transcript. Alternatively or in addition, the specific emotions a person is showing in response to what they are saying/hearing/seeing could be incorporated.

FIG. 13 is an analyzed transcript indicating an emotional display in real time according to one embodiment of the present disclosure. For example, the transcript may be coded to reveal particular emotions of that person at that point in the transcript.

FIG. 14 is a picture showing eye tracking linked with facial coding according to one embodiment of the present disclosure. For example, the picture illustrates how people emoted in response to particular details of, for instance, a presentation of a visual aid that might be used, for example, in court whereby the stimulus in question has also been subject to eye tracking analysis. In some embodiments, the facial coding results and the eye tracking results can be synchronized. The percentages shown may, for example, indicate the degree of positive emotional response that specific areas of the stimulus created in the observer(s), and the hot-spot heat map shown here may indicate by shades of color the decreasing degrees to which the observer(s) focused on that detail of the stimulus such that their eye movements were arrested, or stayed with a given detail, as recorded as eye fixations. Alternatively, a “bee-swarm” output of results could show by observer(s) where each given person's eye gaze went to in absorbing the details of a stimulus.

FIG. 15 is a chart illustrating correlation ratings between the seven core emotions and the Big Five personality traits according to one embodiment of the present disclosure.

FIG. 16 is a chart that illustrates that using a formula, and the corresponding fit between the emotions exhibited by a person and how they fit the formula for a given trait, then a low, medium, or high degree for that given trait can be represented, in according to one embodiment of the present disclosure.

FIG. 17 is a visual depiction of two of the five Big Five Traits and their typical behavioral manifestations, as used in accordance with one embodiment of the present disclosure.

FIG. 18 illustrates two charts comparing natural vs. posed expressions according to one embodiment of the present disclosure. For example, the two charts may compare how AUs are revealed when they are natural, and conversely, when they are posed.

FIG. 19 is a process flow chart of the use of a system according to one embodiment of the present disclosure.

FIG. 20 is a schematic of an automated system according to one embodiment of the present disclosure.

FIG. 21 is a schematic of an interview module of the automated system according to one embodiment of the present disclosure.

FIG. 22 is an example embodiment for collecting video according to one embodiment of the present disclosure. Particularly, the example embodiment of FIG. 19, shows how a web cam or video camera mounted on a personal computer, built into a personal computer, or elsewhere can capture video images of a person or persons as they are speaking, hearing, or seeing oral or written presentations of statements, or otherwise engaged in behavior, in order to capture their facial expressions in response to the stimuli, situation, or environment.

FIG. 23 is a schematic of an analysis module of the automated system according to one embodiment of the present disclosure.

FIG. 24 is a schematic of analysis module software according to one embodiment of the present disclosure.

FIG. 25 is a misapplication example illustrating the optimal Big Five Model trait levels for the target market compared to the Big Five Model trait profile for the endorser, according to one embodiment of the present disclosure.

FIG. 26 is a Big Five Model trait example for a team of athletes, according to one embodiment of the present disclosure.

FIG. 27 is an example of Big Five Model trait analysis for presidential candidates, according to one embodiment of the present disclosure. The far left chart illustrates typical traits representative of republican voters. The middle chart ranks the presidential candidates according to their correlation to the typical traits representative of republican voters. The far right charts identify the Big Five Model trait profile of two of the candidates.

### DETAILED DESCRIPTION

As utilized herein, the phrase “action unit” or “AU” can include contraction or other activity of a facial muscle or muscles that causes an observable movement of some portion of the face, whether detected by a human being or by computerized methods of assessing muscle movement and the repositioning of the facial features and expressions such that the onset or offset of an emotion or emotions is understood to have occurred.

As utilized herein, the phrase “appeal” can include the valence or degree of positive versus negative emoting that a person or group of people show, thereby revealing their degree of positive emotional response, likeability or preference for what they are saying/hearing/seeing. The appeal score may be based on which specific action units or other forms of scoring emotional responses from facial expressions are involved.

As utilized herein, the term “coding to action units” can include correlating a detected single expressional repositioning or combination of contemporaneous expressional repositionings with a known single expressional repositioning or combination of contemporaneous expressional repositionings previously recognized as denoting a specific action unit whereby the detected single expressional repositioning or combination of contemporaneous expressional repositionings can be categorized as indicating the occurrence of that type of action unit. Types of action units utilized in the various embodiments of the present disclosure may include for example, but are not limited to, those established by the Facial Action Coding System (“FACS”).

As utilized herein, the term “coding to emotions or weighted emotional values” can include correlating a detected single expressional repositioning or combination of contemporaneous expressional repositionings with a known single expressional repositioning or combination of contemporaneous expressional repositionings previously recognized as denoting one or more specific emotions whereby the detected single expressional repositioning or combination of contemporaneous expressional repositionings can be categorized as indicating the occurrence of those types of emotions. The emotion(s) coded from each detected single expressional repositioning or combination of contemporaneous expressional repositionings can optionally be weighted as an indication of the likely strength of the emotion and/or the possibility that the expressional repositioning was a “false” indicator of that emotion.

As utilized herein, the phrase “emotion” can include any single expressional repositioning or contemporaneous combination of expressional repositionings correlated to a coded unit. The expressional repositionings can be coded to action units and then translated to the various emotions, or directly coded to the various emotions, which may include but are not necessarily limited to anger, disgust, fear, happiness (true and social smile), sadness, contempt and surprise as set forth in the Facial Action Coding System (“FACS”), and the additional emotional state of skepticism.

As utilized herein, the phrase “engagement” can include the amount or volume and/or intensity of emoting, perhaps by action unit activity, that a person or group of people show in response to a given stimulus or line of inquiry or presentation, or in the case of a group of people, the percentage of people with a code-able emotional response to a stimulus, topic, line of inquiry or presentation.

As utilized herein, the phrase “expressional repositioning” can include moving a facial feature on the surface of the face from a relaxed or rest position, or otherwise first position, to a different position using a facial muscle.

As utilized herein, the phrase “facial position” can include locations on the surface of the face relative to positionally stable facial features such as the bridge of the nose, the cheekbones, the crest of the helix on each ear, etc.

As utilized herein, the term “impact” can include the potency or arousal or degree of enthusiasm a person or group of people show based on the nature of their emoting, based on for example, specific action units, their weighted value, and/or the duration of the action units involved when that is deemed relevant and included in the weighting formula.

As utilized herein, the term “interview” can include asking at least one question to elicit a response from another individual regarding any subject. For example, this can include asking at least one question relating to assessing the person's characteristic response to business situations in general, to situations likely to relate to specific traits among the Big Five Factor model, to questions that pertain to Behavioral Economic principles, or to creating scenarios in which the person is meant to become an actor or participant for the purpose of observing that person's behavior until the simulated situation. An interview may be conducted in any number of settings, including, but not limited to, seated face-to-face, seated before a computer on which questions are being posed, while enacting a scenario, etc.

As utilized herein, the term “Behavioral Economics” can include the school of economics that maintains that people engage in behavior that might not be for the classic economic principle of achieving greatest utility but may, instead, reflect the influence of irrational emotions on their behavior.

As utilized herein, the term “Behavioral Economics principles” can include some or all, but is not limited to, the seven principles of fear of loss, self-herding (conformity), resistance to change, impulsivity, probability blinders (faulty evaluation based on framing, mental accounting, priming, etc.), self-deception (ego), and fairness bias.

As utilized herein, the term “Big Five Model,” “Big Five Factor Model,” or OCEAN can include some or all, but is not limited to, the five personality traits of openness, conscientiousness, extraversion, agreeableness and neuroticism (or stated more positively, emotional stability) that form the basis of the personality model that rests on those five traits as developed by academics such as McCrea and Costa.

As utilized herein, the term “programming” can include the use of facial coding results as depicted upon or in conjunction with the appearance of people in such programming. Examples may include, but are not limited to, showing the emoting of contestants on reality programs, a politician giving a speech at a national party convention, a suspect on a crime program, or an athlete giving a post-game interview.

As utilized herein, the term “scenario” shall include a case where the interview might involve not just questions to be answered but also a situation or scenario. For example, a scenario may include asking a potential sales force hire to simulate the sequence of making a cold phone call to a prospect and detecting what emotions appear on the person's face in being given the assignment, as well as in enacting it or discussing it afterwards.

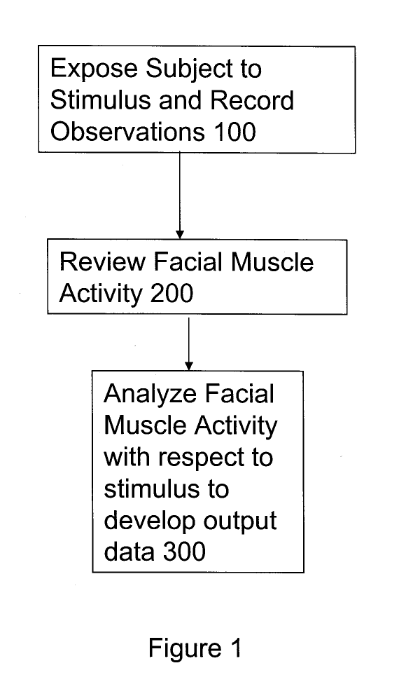

Among its embodiments, the present disclosure can be directed to overcoming the problems inherent in relying on verbal input alone in assessing the personality type, behavioral tendencies, credibility, motivations, etc., of people by supplementing or replacing such verbal analysis with the analysis of people's facial muscle activity and expressions. A method of doing so, applicable across instances or opportunities such as those detailed above in the Background, is illustrated in FIG. 1 and may involve first either watching in real-time or capturing on video the non-verbal expressions and reactions of people to emotional stimulus 100. Said stimulus can be anything ranging from a structured interview with questions, to their behavior during planned or impromptu scenarios (such as a sales person enacting a cold call to simulate ability to make such calls), to behavior and responses captured intentionally or inadvertently on video, including during the watching of television programming or to other stimuli, to reading the expressions of people who are appearing in television programming, to programming, video, or photographs shared through the Internet or other network or mobile devices, to verbal and non-verbal expressions during a trial or a deposition, etc.

Step one of the method as described above, in one embodiment, for instance, may use questions or scenarios that are standardized to allow for norms and a standard by which to therefore measure the degree to which the emotional response detected is suitable for the application in question, such as but not limited to, a job interview or training practice. For example, the same five questions, each related to a different way of assessing a person's work tendencies or capabilities, could be used, or a specific number of questions, set of instructions for, and/or amount of time allotted for a scenario to be enacted could be used.

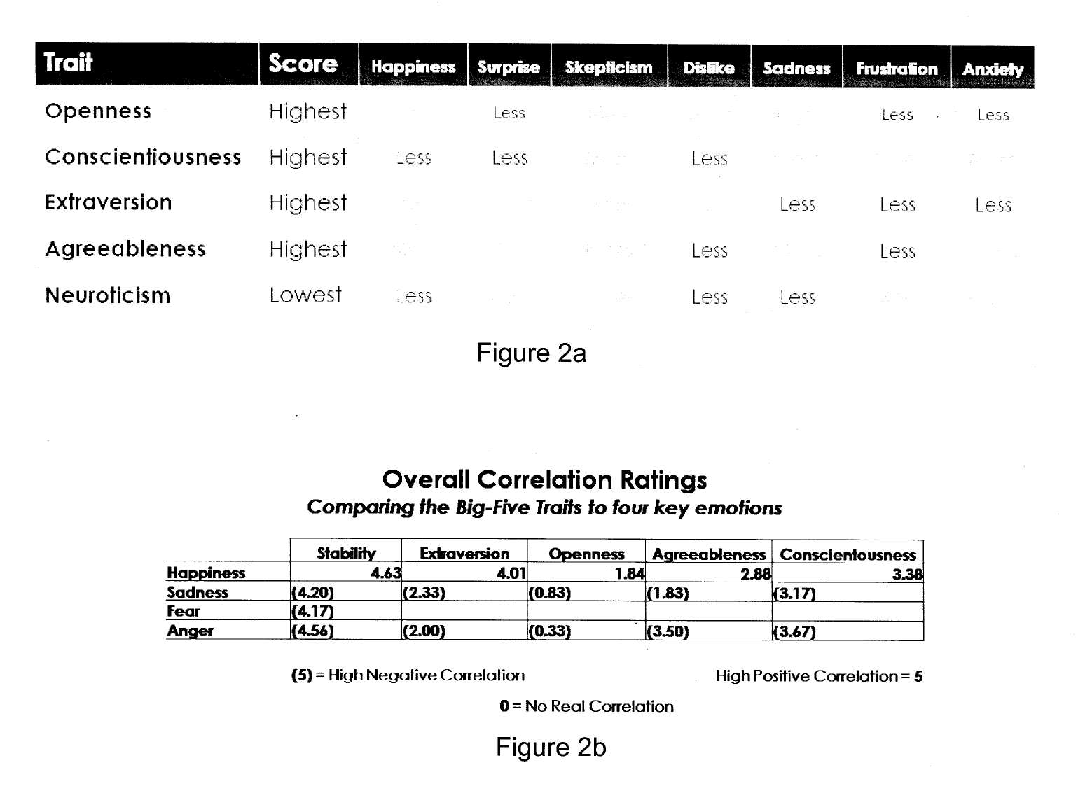

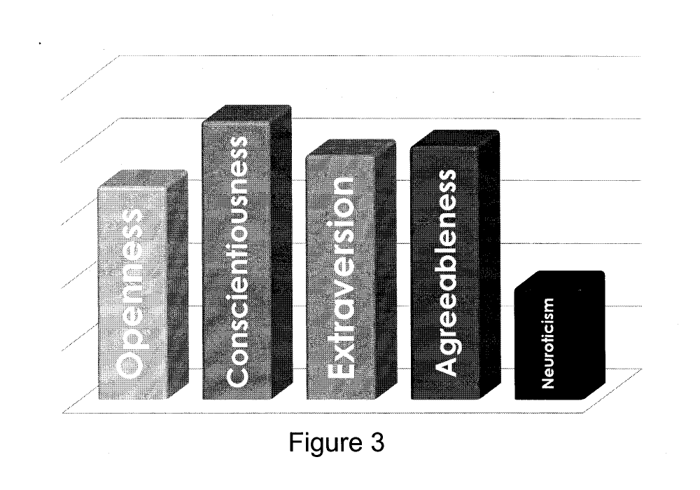

One embodiment may use standardized questions to determine a person's Big Five Factor Model personality type through a structured interview that can include, for example but not limited to, one or more questions per each of the OCEAN traits, for the purpose of capturing emotional data that can then be correlated to personality type. This goal could be achieved on a standard basis by profiling the mixture and predominant display of emotions that best fits a given Big Five Factor personality trait. FIGS. 2a and 2b are charts that generally show manners in which some emotions may be linked to each of the OCEAN traits. FIG. 3 is an example graphic representation of a person's Big Five Model personality type as revealed based on the facial muscle activity or expressions results from a sample piece of video and/or specific line of questions.

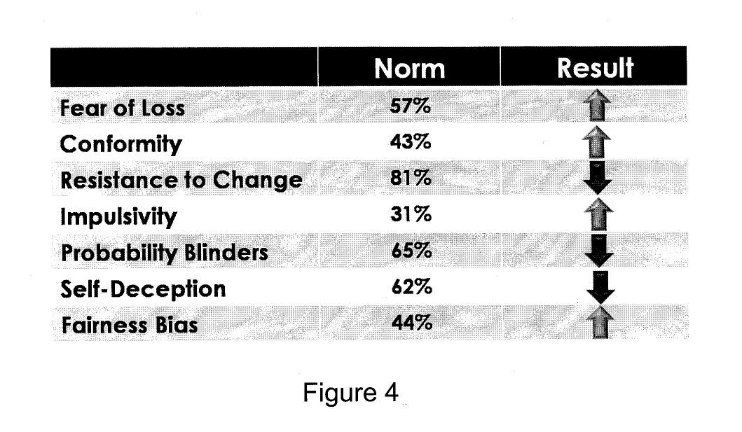

Another embodiment may use scenarios and/or questions to evaluate a person in regard to their behavioral economics. The questions could elicit answers to the key principles such as loss aversion, conformity, fairness bias, etc. One or two, or another suitable number of questions, for example, can be asked specific to aspects of the key tenets of Behavioral Economics, such as the set shown in FIG. 4. FIG. 4 is an example graphic representation of how the facial muscle activity or expressions results, in alignment with biases that pertain to Behavioral Economics, reveal the tendencies of the person or group of people to be susceptible to those behavioral vulnerabilities. A norm might, for instance, reflect the degree to which people are emotionally susceptible to a given tendency, based on a formula of specific emotions they display most prominently in response to a given question, with the result showing whether they are above, below, or within a specified range of what people reveal emotionally in regards to that tendency.

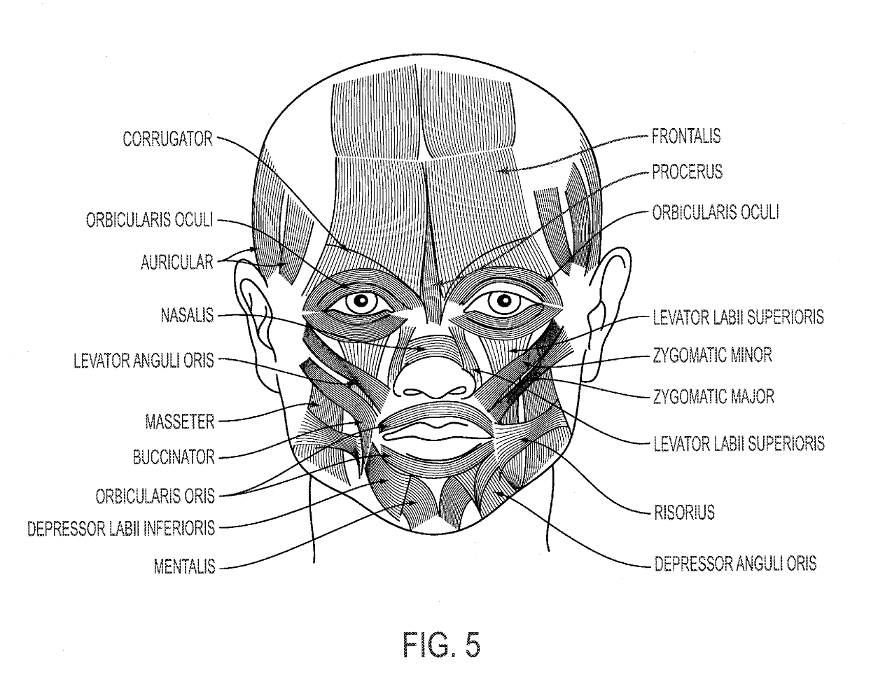

Referring back to FIG. 1, a second step 200 may involve observing in real-time the facial muscle activity and expressions of the people in question or of reviewing the video files of same, whether such review is done manually or by using emotional recognition software, e.g., automated facial coding. There are some 43 facial muscles that might be taken into account for the purpose of detecting singular instances of muscle movements and expressions, or of posed or held expressions, or patterns of muscle activity movements over time. FIG. 5 is an illustration of a human face indicating the location of several facial features which can be conveniently utilized. This observation or review can involve, for example, noting the general mood or emotional state of an individual, such as sad, happy, angry, etc., by means of general patterns of movement or state of expression, or by specific movements as they relate to given emotions.

Step two of the method can utilize standards to analyze emotions. In this case, among the approaches available for analyzing facial muscle activity and expressions, one option generally stands out among the others for its rigor and extensive documentation. That option is known as facial coding. Facial coding originated with Charles Darwin, who was the first scientist to recognize that the face is the preferred method for diagnosing the emotions of others and of ourselves because facial expressions are universal (so hard-wired into the brain that even a person born blind emotes in a similar fashion to everyone else), spontaneous (because the face is the only place in the body where the muscles attach right to the skin), and abundant (because human beings have more facial muscles than any other species on the planet). Facial coding as a means of gauging people's emotions through either comprehensive or selective facial measurements is described, for example, in Ekman, P., Friesen, W. V., Facial Action Coding System: A Technique for the Measurement of Facial Movement (also known by its acronym of FACS), Consulting Psychologists Press, Palo Alto, Calif. (1978), which is hereby incorporated by reference in its entirety herein. Another measurement system for facial expressions includes Izard, C. E., The Maximally Discriminative Facial Movement Coding System, Instructional Resources Center, University of Delaware, Newark, Del. (1983), which is also hereby incorporated by reference in its entirety herein.

In accordance with FACS, the observation and analysis of a person's facial muscle activity or expressions can therefore be conducted by noting which specific muscle activity is occurring in relation to the FACS facial coding set of muscle activities that correspond to any one or more of seven core emotions: happiness, surprise, fear, anger, sadness, disgust, and contempt, or others such as might be determined in the future. According to FACS, there are approximately 20 or so facial muscle activities that on their own or in combination with other muscle activities—known as action units or AUs—can be correlated to the seven core emotions. To engage in facial coding properly, an observer would want to be systematic by reviewing a given person's video files to establish, first, a baseline of what expressions are so typical for the person as to constitute a norm against which changes in expression might be considered. Then the video files would be watched in greater depth, with slow-motion, freeze-frame and replays necessary to document which specific AUs happen and at what time interval (down to even 1/30^{th} of a second) to enable review or cross-checking by a second facial coder in the case of manual coding, or human checkers to verify in the case of semi- or fully-automated facial coding. See by way of reference, Table Two and Table Three in U.S. Pat. No. 7,113,916 (granted Sep. 26, 2006 to inventor), which is hereby incorporated by reference in its entirety herein.

Another option for analyzing emotions is disclosed in Proceedings of Measuring Behavior 2005, Wageningen, 30 Aug.-2 Sep. 2005, Eds. L. P. J. J. Noldus, F. Grieco, L. W. S. Loijens and P. H. Zimmerman and is incorporated by reference herein in its entirety. The article details a system called FaceReader™ from VicarVision that uses a set of images to derive an artificial face model to compare with the expressions it is analyzing. A neural network is then trained to recognize the expressions shown through comparison between the expression and the model.

Referring back to FIG. 1, a third step 300 can be to, in some fashion, assemble one's data of what was seen in terms of facial muscle activity and expressions in order to draw some conclusions. Such analysis can range, for example, from noting the person's general mood or characteristic emotion or emotional displays, to correlating their emotional reaction to a specific question, situation (e.g., participation/performance in an amateur or professional sporting event), environment (e.g., in the case of a shopper), stimulus (e.g., in the case of a mock jury member, for instance, responding to a visual aid being considered for display in court to make a point), or for marketing segmentation purposes, the watching of a visual program, such as but not limited to a television programming or video. In addition, potential discrepancies or notable instances where a person's self-representation of facts, or attitudes, etc., seem at odds with the emotions evident might be worthy of noting for further exploration. Such analysis could also conclude that the person is in general or in regards to specific questions or stimuli of a positive, neutral (non-expressive or ambivalent) or negative emotional disposition, for example.

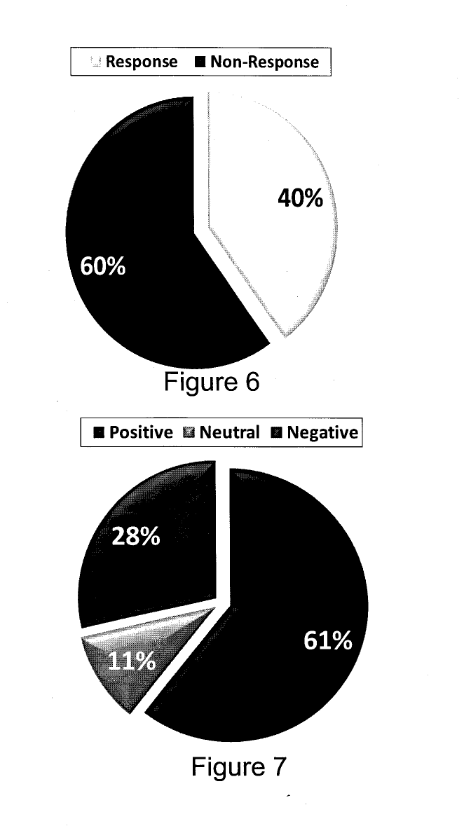

Step three of the method can be implemented by deriving a standard set of measures to be taken from the facial coding results. As an outgrowth of what was just described above, this approach can benefit from noting which AUs occur in relation to what specifically is being said, by question, by subtopic within the answer given, or in relation to a stimulus shown, etc. Then the action units or AUs can be tallied such as to arrive at an array of statistical outputs. One that may be of interest in a range of situations including, for example, whether a job applicant is enthusiastic about a given portion of the job role, whether a potential romantic partner really enjoys an activity you like, or whether a potential witness or jury member is riled up by an aspect of the case in question, is to track engagement or emotional involvement level. This measure can be taken, for instance, by considering the amount of time (e.g., duration) when a person was expressing an emotion while talking on a given topic, the amount of AUs the person showed (e.g., volume), or in a mock jury presentation, for instance, the percentage of people who expressed an emotion when a line of argumentation was tried out. FIG. 6 is an example graphic representation to indicate the amount of emoting, by action unit, based on duration or volume to indicate how motivated or engaged a person or people are by what they are saying/hearing/seeing/doing. When a plurality of subjects are involved, such as with a mock jury, then a percentage of the subjects who are emoting during the presentation of a particular topic or line or argumentation can also be used.

In terms of statistical output, another way that the facial coding results can be depicted is to provide a percentage of positive, neutral, or negative response to a given question, scenario, etc. For instance, one systematic approach could be to consider a person as having had a predominantly positive reaction to a posed question, answered by said person, if that person, whether a job applicant, potential romantic partner, or potential jury member, for instance, emoted showing happiness and/or surprise at least 50% of the time during the response. In such a case, a neutral response might be based on emoting happiness and/or surprise for, for example but not limited to, 40 to 50% of the emoting during the response, whereas a response categorized as negative for facial coding purposes would then fall below the 40% mark. By way of example, FIG. 7 is a sample graphic representation of the percentage by which a person or group of people might be predominantly positive, neutral, or negative regarding what they might be saying/hearing/seeing/doing during a specific point in an interview, for instance, or over the duration of an interview, mock jury presentation, etc.

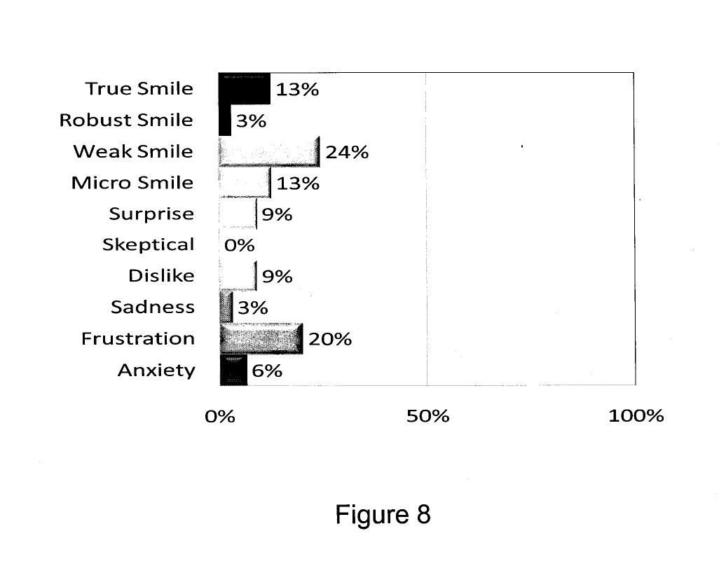

In terms of statistical output, yet another output that can be used is to document the degree to which the emotions shown can be divided up into either the seven core emotions or some other type of systematic display of results. One embodiment can be to take the FACS seven core emotions and divide them into, for example, ten emotional states, five positive and five negative. We could then use AUs (identified by number: see FACS) to represent the specific emotions. For example, the positive emotional states could comprise a true smile (AU 6+12) or the highest true smile of happiness, a robust social smile (AU 12) with cheeks prominently raised, a weak social smile (AU 12) with checks barely raised and teeth not showing or barely, a micro-smile (AU 12) when the smile is unilateral and perhaps also brief, and surprise (AU 1, 2, 5 and 26 or 27 or potentially any combination thereof) as the final element of a positive reaction, or else with surprise treated as a neutral expression, or as positive or negative depending on what other type of emotion is expressed simultaneously or immediately thereafter. Meanwhile, in regard to the negative emotional states, there could be dislike (a combination of disgust and contempt, involving potentially AUs 9, 10, 14, 15, 16, 17, 25 or 26 or a combination thereof or singularly), sadness (AU 1, 4, 11, 15, 25 or 26 and possibly 54 or 64 or a combination thereof or singularly), frustration (AU 4, 5, 7, 10, 17, 22, 23, 24, 25, 26 or a combination thereof or singularly), or anxiety, namely fear (AU 1, 2, 4, 5, 20, 25, 26, 27 or a combination thereof or singularly). That leaves skeptical, which in one embodiment, might constitute a smile to soften the “blow” as a negative or sarcastic comment is being made. FIG. 8 is an example graphic representation of the specific emotions that a person or people are revealing in response to what they are saying/hearing/seeing/doing regarding a specific topic or scenario being enacted or line of argumentation, as described above.

Another embodiment of the scoring system for AUs relative to specific emotions might be to take into account the various combinations of AUs that can constitute a given emotion along a couple of lines of development. One way can be to treat each AU individually and assign its occurrence by even percentages to each and every pertinent emotion to which it might apply. A second embodiment here might be to, in contrast, weight each AU by ever greater degrees in favor of a given emotion when other AUs are simultaneously or in close timing also evident, whereby the variety of AUs being shown in a short time span can, for instance, tilt the result in favor of concluding that a given emotion is the predominant emotion being displayed. By way of example, consider a case where AU 2 is shown by itself. As this corresponds in FACS terms to both fear and surprise, by itself it might be assigned on a 50% fear and 50% surprise basis. But if AU 2 occurs in proximity to AU 11, which fits sadness only, then AU 11 might be 100% assigned to the sadness category, with AU 2 in turn now receiving a 66% weighting in favor of sadness and now only 33% surprise. Other such systematic formulas could follow to allow for the many combinations of AUs possible. For example, see U.S. patent application Ser. No. 11/062,424 filed Feb. 20, 2005 and incorporated herein by reference in its entirety. See also U.S. Pat. No. 7,246,081 and U.S. Pat. No. 7,113,916 issued to the Applicant and which are also each incorporated herein by reference in their entirety.

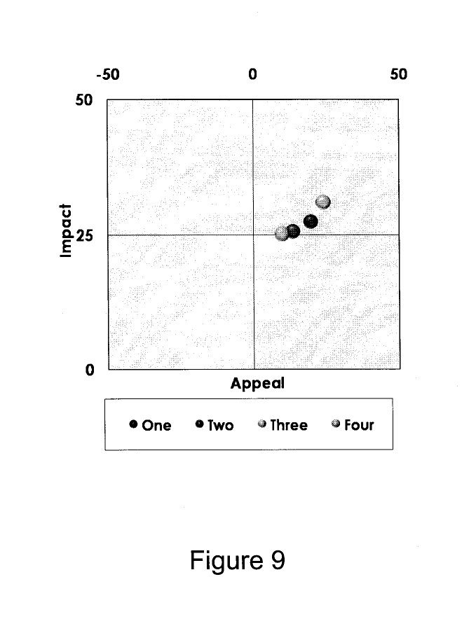

In terms of statistical output, yet another output that can be used is to graph the results onto a quadrant chart. In this case, the two vectors that might be used could be drawn from psychology, which often considers the potency or arousal dimension of, say, an emotional response, herein referred to as impact, along with the valence or degree of positive versus negative emotional response, or likeability or preference, herein referred to as appeal, as a possible second dimension or vector in presenting the results on a quadrant chart. FIG. 9 is an example graphic representation of the impact and appeal values, shown on a quadrant chart, to indicate by person, in a lineup of positive job hires, for instance, who emotes with the most impact and/or appeal to a particular question versus another, or on average for one person versus others.

In another embodiment, each of the AUs singularly or perhaps by virtue of an array of combinations can in each instance be assigned an impact or appeal weight developed in a formula. In turn, each impact and appeal value for each type of emoting that occurs in response to a given question, during a scenario, or overall in response to, for instance, a mock jury presentation or emotional profile of a potential romantic partner could then be accumulated to arrive at the type of presentation of results shown in FIG. 9. Alternatively, the impact and appeal scores could have its accumulative total divided by time duration, by number of people involved, be shown against a norm, and so forth. U.S. patent application Ser. No. 11/062,424 further describes the use of weighted values and weighted formulas.

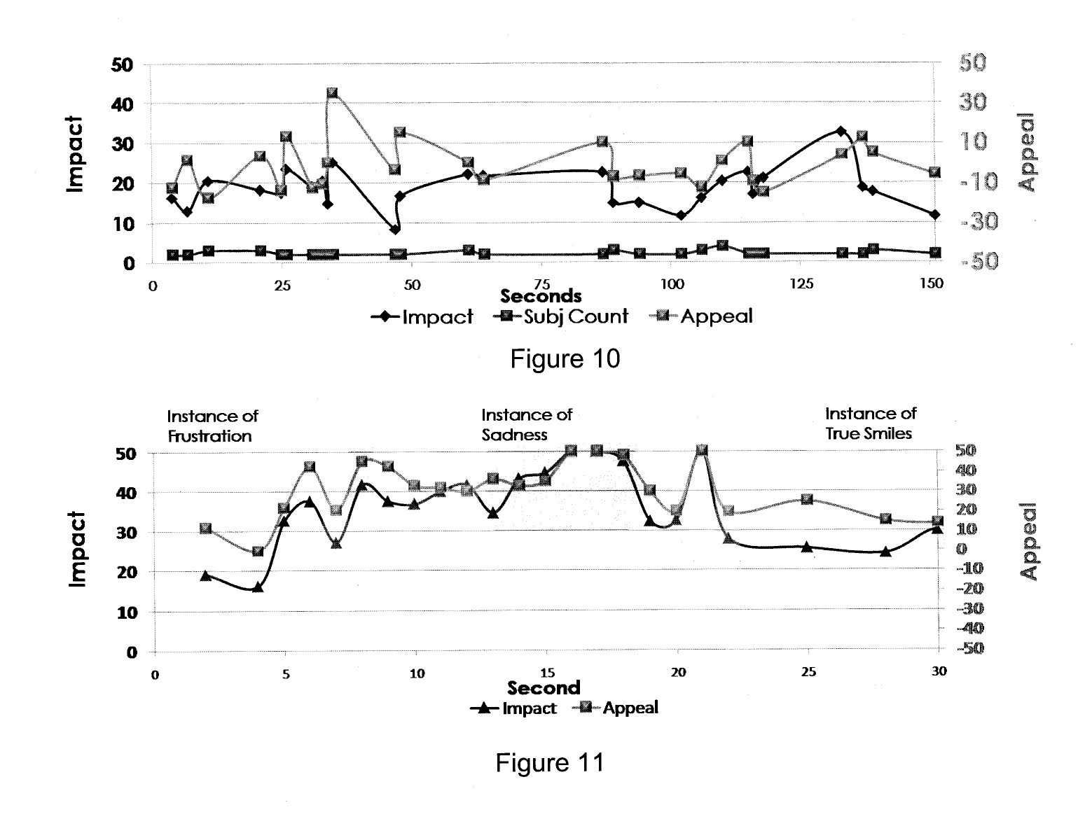

In terms of statistical output, yet another output that can be used while bearing a potential relation to the impact and appeal scoring approach is to construct a timeline. In this case, for example, a data point or feeling point can be shown when at least two subjects out of a sample of subjects had a code-able emotional response within the same split-second, for example, to a stimulus. Such an approach can still work well with a mock jury, for instance. In another embodiment, however, where individuals are involved, an emotional data point might be shown each and every time emoting takes place and the subject count would, if included, note the amount of AUs that were occurring at that time, or else perhaps their level of intensity, seeing as FACS now has 5 levels of intensity for each AU shown. FIG. 10 is an example graphic representation of the impact and appeal values, based on proprietary scoring weights for the action units shown by a person or group of people, to a statement, audio presentation, etc., to indicate at which points in the presentation people are emoting most and in what ways to reveal the relevancy and interest and type of response they have to the presentation being given.

In terms of statistical output, yet another output that can be used is to augment the second-by-second chart shown in FIG. 10 by highlighting which emotion or emotions exist in relation to each emotional data point or else are perhaps predominant at certain points when response level is greatest. An example of this type of output option is shown in FIG. 11.

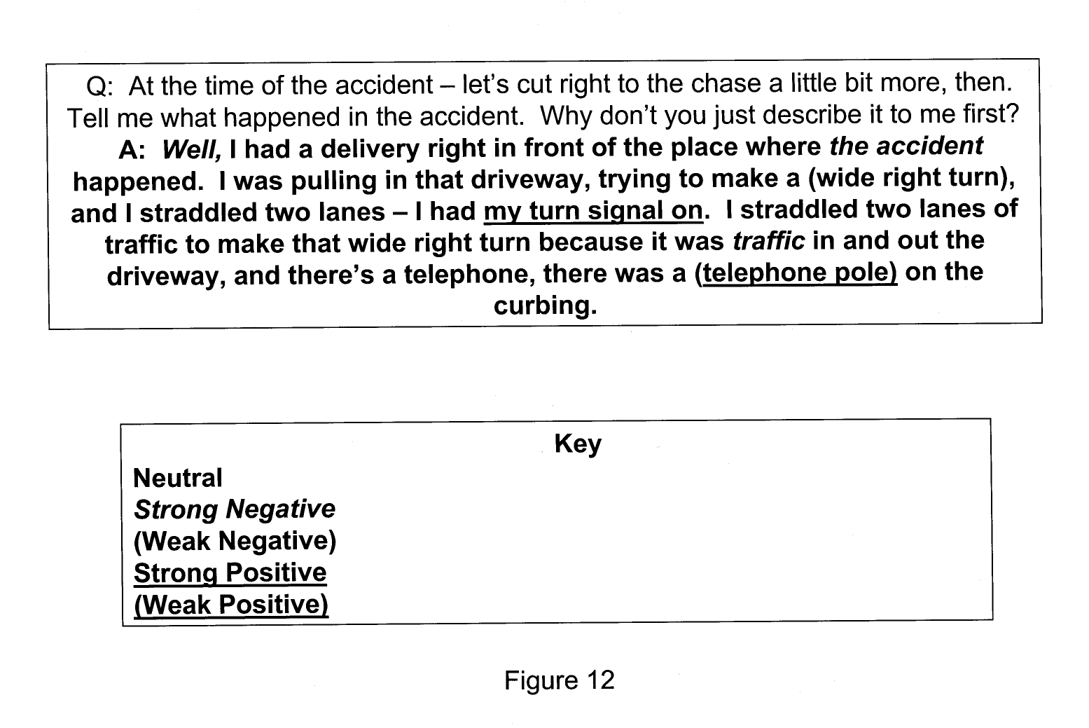

In terms of statistical output, yet another output that can be used is to take a given transcript, whether from a witness with a videotaped deposition, a person eligible for jury selection, a person in a job interview, or a person who might be a potential romantic partner, etc., and correlate the transcribed transcript such that when the person emoted, that response can be shown in relation to what was being said or heard at that given point in time. This correlation can in turn be shown in a variety of ways, including but not limited to, whether the emotions shown are positive, neutral, or negative based on the predominant emotion(s) shown, or by percentage based on a formula, and/or by considering the type of AU involved and thus the degree to which the emotional response is positive or negative in terms of valence. FIG. 12 is an example graphic representation of when a transcript of somebody's response to a question, statement, or videotaped deposition, for instance, has been coded to reveal the positive or negative valence or appeal of that person at that point in the transcript. Alternatively or additionally, the specific emotions a person is showing in response to what they are saying/hearing/seeing could also be incorporated.

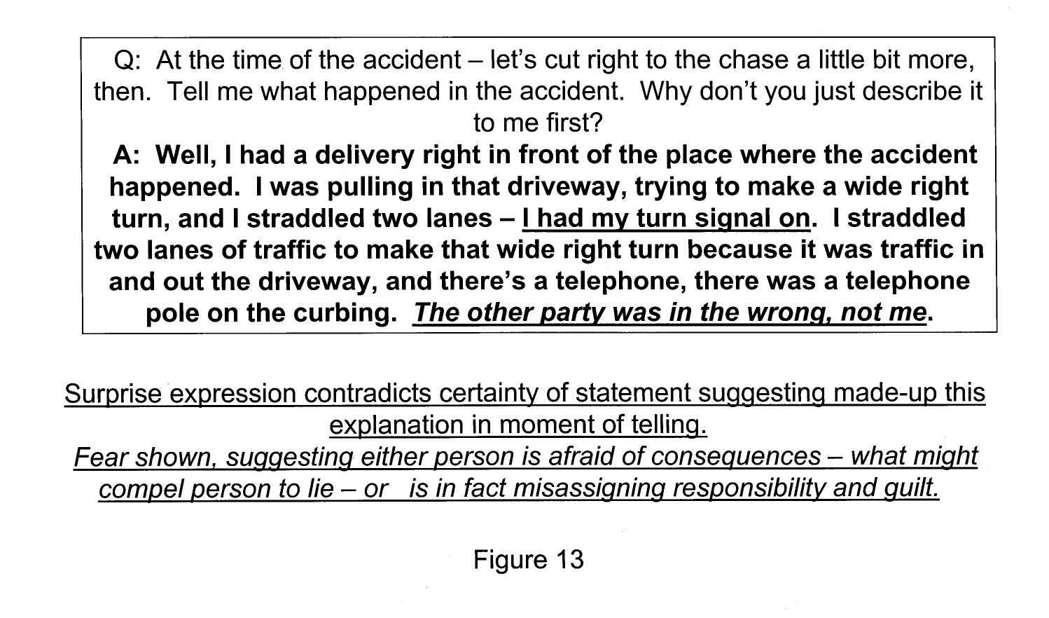

In terms of statistical output, yet another output that can be used is to construct a variation of the FIG. 12 example, wherein the coded transcript can likewise be flagged to indicate discrepancies between the coded transcript and the topic in question, in cases where a person's veracity might be suspect or heavy in emotive volume and, therefore, worthy of further investigation. An example of this type of output is shown in FIG. 13. Such an example could be of special interest, for example but not limited to, a political debate, a reality show contestant “confiding” their thoughts and feelings about fellow contestants on the show, or an athlete or coach describing their performances and those of others within the organization or on an opposing team.

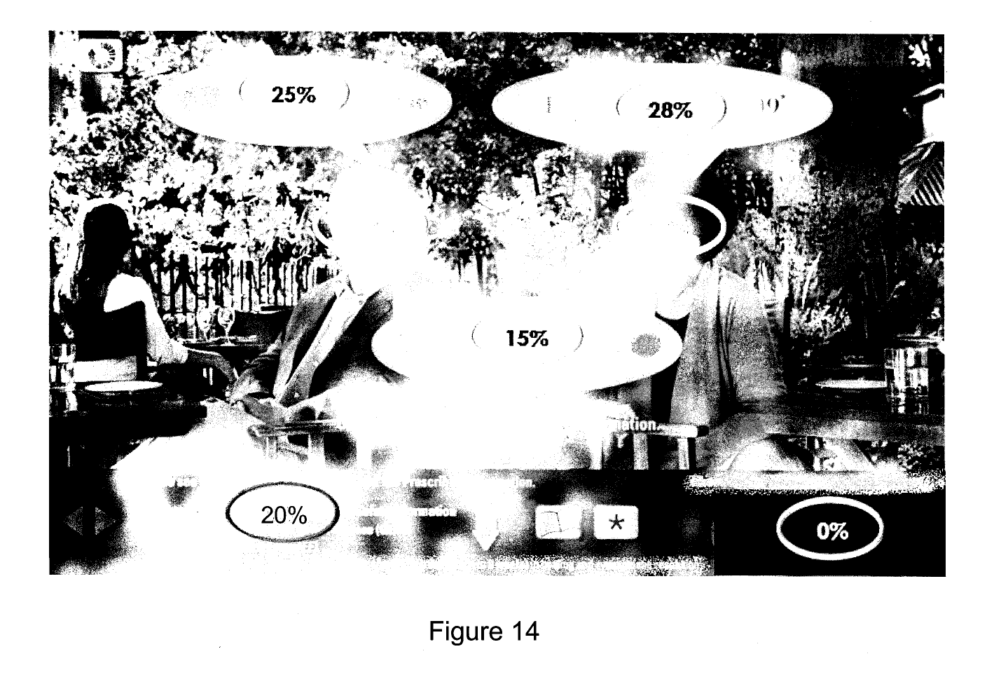

In terms of statistical output, yet another output that can be used is to consider an example like a mock jury being shown a visual aid intended for courtroom display and discern where the subjects look based on the use of eye tracking and how they feel about what they are taking in, using facial coding. For background, see U.S. Pat. No. 7,930,199, titled “Method and Report Assessing Consumer Reaction to a Stimulus by Matching Eye Position with Facial Coding,” the entirety of which is hereby incorporated by reference herein. Such synchronization of eye tracking results and facial coding results can of course be utilized in other fashions, too, for matters involving personnel such as how a job applicant inspects and reacts to company advertising, ethics guidelines, etc. FIG. 14 is an example graphic representation of how people have emoted in response to particular details of, for instance, a presentation of a visual aid that might be used in court whereby the stimulus in question has also been subject to eye tracking analysis, with the facial coding results and the eye tracking results synchronized. The percentages shown here indicate the degree of positive emotional response that specific areas of the stimulus created in the observer(s), with the hot-spot heat map shown here indicating by shades of white to different levels of grey to black the decreasing degrees to which the observer(s) focused on that detail of the stimulus such that their eye movements were arrested, or stayed with a given detail, as recorded as eye fixations lasting at least 1/50^{th} of a second. Alternatively, a “bee-swarm” output of results could show by observer(s) where each given person's eye gaze went to in absorbing the details of a stimulus.

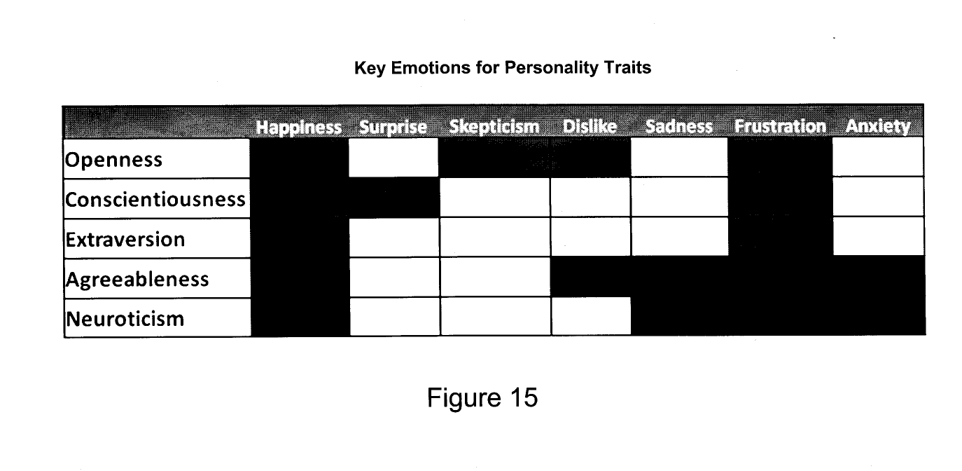

Generally, the various embodiments of the present disclosure may take emotional results data per person and plug into a formula to automate statistical facial analysis. For instance, based on a series of studies involving the exposure to test subjects of stimuli to which they emoted, with their emoting tracked by type of emotion shown across multiple exposure, and then that emoting linked in turn to how the subjects self-reported their personality based on the Big Five Model, a better mode, subject to refinement over time with additional studies, becomes possible. As shown in FIG. 15, in one embodiment, instead on just four (as shown in FIG. 2b), all seven of the “core” emotions built into FACS may be represented. Moreover, they may be represented by invoking behavioral data, through facial coding, rather than relying on self-reporting data alone.

More specifically, FIG. 15 indicates which emotions, whether shown more often and strongly, or less often and more weakly, pertain to each of the OCEAN traits. From that, in either an after-the-fact, analytical basis or potentially even in real-time based on the availability of mobile computing devices or through observation, the determination of an individual's personality type might be reasonably secured. As a result of securing the emotions to personality traits correlations identified through FIG. 15, it can then become possible to generate a personality profile.

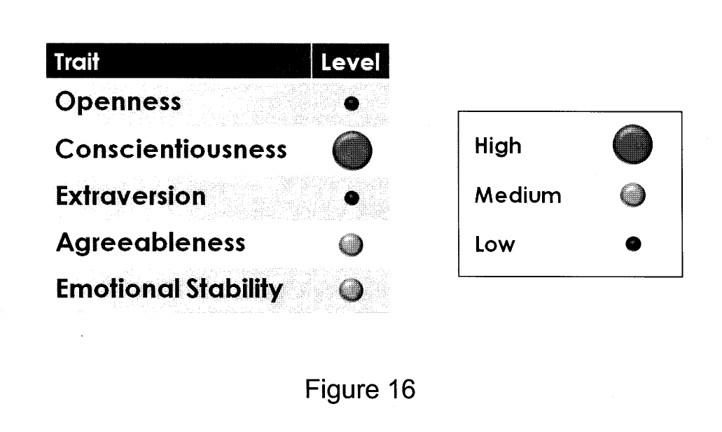

FIG. 16 depicts that using the formula illustrated in FIG. 15 and discussed above, and the corresponding fit between the emotions exhibited by a person and how they fit the formula for a given trait, then a low, medium, or high degree for that given trait can be represented. The resulting profile can be a desirable value-add to many embodiments of the present disclosure because for analytical purposes, it may then allow one to gain both a concise, immediate understanding of the person involved as well as draw on the wealth of psychological literature investigating the Big Five Model and its implications for people's behavioral patterns, motivations, and receptivity to advertising among other manifestations.

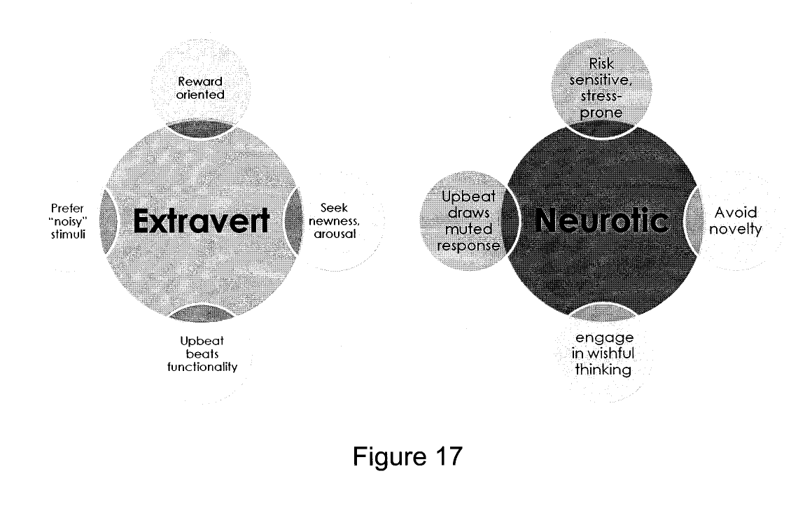

For instance, the likely outcome orientation, level of attention, action bias, risk tolerance, and decision-making style of somebody subject to a given emotion is reasonably well documented. See, e.g., the Primary Emotional States table described in Hill, D., Emotionomics: Leveraging Emotions for Business Success, Kogan Page (Nov. 28, 2010), which is hereby incorporated by reference in its entirety herein. Adding on to such knowledge is the likely profiles of somebody for whom a given trait is most prominent, for instance, such that as shown by FIG. 17, one might then reasonably conclude that a person exhibiting that trait as the leading or defining trait, in combination with one or more other most prominent or recessive traits, might be understood, for example but not limited to, for the purposes of drafting a segmentation scheme that will serve as the basis for marketing to people in that segment more effectively.

Extrapolating from the available psychology literature and applying it to business practice, it might then be fair to make a variety of strategic marketing conclusions. Among them is that for new product launches, early adopters are likely to be high on Openness (to what's new) and Extraversion (because they like to share their discoveries with friends). Social media types are likely to be highly extraverted and agreeable, enjoying interaction with others. On the other hand, Customer Relationship Management is likely to be wasted on those who are introverts (low on Extraversion) and who are not especially agreeable, meaning they don't welcome the intrusion of database-driven e-mails, et cetera, from marketers.

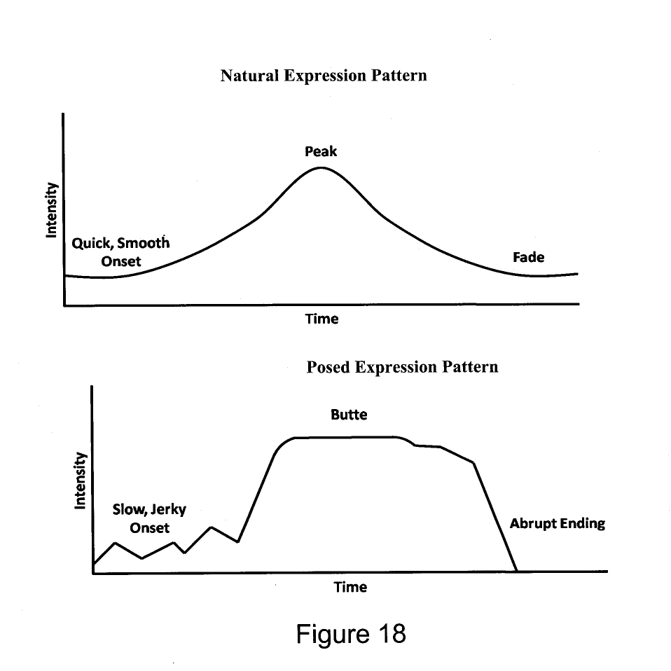

Another embodiment can utilize frame-by-frame, split-second measurements to aid in the detection of possible instances of lying by taking into account a variety of patterns. Natural, involuntary expressions originate in the sub-cortical areas of the brain. These sub-cortically initiated facial expressions are characterized by synchronized, smooth, symmetrical, consistent, and reflex-like facial muscle movements where volitional facial expressions tend to be less smooth. Thus an embodiment of this disclosure can account for whether a muscle activity has a natural onset (smooth and fast, versus slow and jerky onsets for posed expressions), a peak and offset such that the emotion being shown flows on and off the face without the jerky onset, sudden ending rather than a natural fade or offset, or protracted peak—hereby dubbed a “butte”—that can mark an expression that may not be authentically felt. Likewise, software, as part of a system as described herein, may aid in noting expressions that are asymmetrical, such that one side of the face reveals the expression more than the other (in generally most cases except for contempt expressions, which are inherently unilateral) as an indication that the expression may be forced onto the face or otherwise contrived. Identifying odd timing, such that the expression arrives too early or late in conjunction with expressed statements and is, as such, out of synch, identifying mixed signals, where negative emotions accompany or are in the timing vicinity of a smile, noting when a surprise look or smile lasts more than expected, and detecting whether multiple action units peak simultaneously, or fail to do so, can be clues to an unnatural, posed expression. An example of a natural vs. posed flow for an action unit is shown in FIG. 18. As can be seen from FIG. 18, a natural expression typically exhibits a quick, smooth onset as the facial muscles relevant to a given action unit contract, extend, bulge, etc., a distinctive peak or apex where the intensity of the expression is strong, and an offset or fade whereby the action units subsides. In contrast, a faked, posed, voluntary, controlled or otherwise consciously mediated expression will more likely exhibit a slow, jerky onset, sustain itself as a “butte” with a distinct peak, and end quickly such as in the case of a “guillotine” smile that drops abruptly off the face.

One embodiment of the method of using non-verbal facial muscle activity or expressions to gain greater insights about an individual's personality type, behavioral tendencies, credibility, motivations and other such insights related to applications including but not limited to personnel hiring, career development, training, interne dating, and the analysis of people involved in law suits as witnesses or in actual or mock/shadow juries is to detect and note manually, in real-time if possible, the overall emotional look or expression that an individual might have at a given moment in response to a question, exposure to a stimulus, in enacting a scenario, being in a performance situation, etc. Thus, an outcome might be an analysis in which the conclusion is that somebody felt/looked “scared” when asked a given question. As an alternative to such an embodiment, either the person conducting the interview or else the person in question may work from a set of photographs, each showing a person exhibiting a given emotion, and selecting the one that best represents the person's overall emotional state, look, or feeling that seems to have been evoked.

In another embodiment of the method, muscle activity contractions or other forms of movement might be observed and so noted, including the duration, intensity, and exact timing of such muscle activity or resulting, prevalent expressions. In this embodiment, the observation may be performed either manually by reviewing the video on, for example, a second-by-second basis to identify in terms of generalized movements and their meaning, what the person in question is feeling; or such analysis might be performed using a computerized system, as described in U.S. patent application Ser. No. 11/062,424, for example. The observation method, for instance, may be desirable in some instances, such as but not limited to, in observing a professional athlete in a practice session or during some other event where video-recording the session, with the camera angles desired, may not be feasible, or where a contestant is shown close-up during a cut-away interview on a television reality program. In some embodiments, the outcome can be to note the take-away dominant emotion or emotions that a person is feeling, labeled, for example, as anger, fear, etc. or a combination thereof based, for instance, in concluding that since anger typically involves the contraction or tensing of muscles, and such was seen, then the person is exhibiting signs of anger. In contrast, cases where the face elongates, with raised eyebrows, mouth dropping open, etc., constitute, for example, signs of surprise.

In yet another embodiment of the method, muscle activity contractions or other forms of movement might again be observed and so noted, including the duration, intensity, and exact timing of such muscle activity or resulting expressions. In this embodiment, the observation may be again performed either manually by reviewing the video on a second-by-second basis to identify in terms of generalized movements and their meaning, what the person in question is feeling; or such analysis might be performed using a computerized system, as described in U.S. patent application Ser. No. 11/062,424, for example. In this particular embodiment, facial coding based on the use of FACS or some other specific facial muscle activity coding system whereby a given facial muscle activity correlates to a specific unit of analysis, such for instance that the chin rising can be at once a sign, for example, of anger, disgust, and sadness, can then in turn allow for the distinguishing of an array of emotional displays, with each, as an optional embodiment, being given a weighted percentage, leading, as another optional embodiment, to a range of scoring system outputs to identify the emotional displays that have been observed.

In yet another embodiment of the method, moreover, those displays can be construed to create a series of metric outputs, either directly related to the emotions shown, such as indicating the impact or intensity of emotions shown, and/or the appeal or valence of the emotions shown, etc. In a version of such an embodiment, analysis might proceed to correlate the emotional displays to determining or confirming the personality type of an individual, susceptibility to Behavioral Economic tendencies, degree of credibility, innate enthusiasm, or engagement in a given topic, among other possibilities. In this and any embodiment related to a particular individual as the focal point, it can the be possible to draw correlations between emoting results and the Big Five Model of personality traits.

Moving on to segmentation across multiple individuals, in yet another embodiment of the disclosure, it might be used by facial coding a sample of consumers. Half the sample might be those who are current purchasers of a company's branded offer, and the other half could be those who are only occasional buyers because they split their loyalty with another brand. By having both of these subgroups get exposed to a common set of stimuli and/or questions, the emoting differences between the two groups can be statistically assessed. And from the differences, and using the table with the traits/emotions correlations, the traits of both subgroups can be learned and serve as the basis for how best to understand and market to the respective subgroups, thereby arriving at traits segmentation.

In yet another embodiment of the disclosure, consumers might be sent a series of direct mail pieces based on having one or two traits emphasized. In other words, the mailing might be designed in imagery and words to appeal to somebody whose personality profile has atypical, pronounced levels of neuroticism and conscientiousness. Another mailing might be aimed at extraverts. Another might be aimed at those who are agreeable and open, for instance. By then tracing by recipient of the direct mail pieces, the relative response rate—by individual—to each of these different mailings, sent on a randomized order basis, it might be reasonably possible to draw a conclusion as to which trait profile the individual fits into, and across the tested sample population, what the personality traits are of the ideal target market. Then, informed by that knowledge, subsequent mailings can better fit the personality traits profile, i.e., the personality segmentation of the target market.

In yet another embodiment of the disclosure involving segmentation potentially, but also the ideal programming on which to advertise, the CEO or other employee of a company and company spokespeople, including celebrities who appear in the advertising, might be facially coded to understand what the company's projected personality might be, and whether those leading personalities match up well with the actual traits segmentation of the target market. Or to arrive at effective advertising, the emotions exhibited and, thus, the traits of characters in television shows might be deduced, or the emotional dynamics within the show, or a single plot, or a scene within a plot might be deduced, in order to try to match up the ideal programs during which advertise based on the nature of a company's offer and the type of advertising/video it has available, thus providing a match up between the creative elements of its advertising, including the characteristic facial expressions of the actors, their traits, and so on, vis-à-vis the television show creative elements, and the personality of the target market as known through other embodiments of the disclosure.

The method may involve, in general, the reading of emotions through facial coding as well as the ability to link those emotions to traits on a non-verbal, other than self-reported basis. As a means of affirming the accuracy and validity of the emotions to traits correlations shown in FIG. 15, it is possible to draw on other observation techniques as well. For instance, despite the often limited verbal abilities of adults, let alone a child, some academics have been exploring the ability to use linguistic cues for the automatic recognition of personality in conversation and text. See, e.g., Using Linguistic Cues for the Automatic Recognition of Personality in Conversation and Text, authored by Francois Mairesse, Marilyn A. Walker, Matthias R. Mehl, and Roger K. Moore, in the Journal of Artificial Intelligence Research 30 (2007) 457-500, which is hereby incorporated by reference in its entirety herein. Other academics hold out hope that that the Big Five Traits might be self-evident in a behavioral/functional setting, such as how individuals navigate a web site or other technology mediums, involving language and/or graphics/visuals. See, e.g., Language and Personality in Computer-Mediated Communication: A Cross-Genre Comparison, authored by Alastair J. Gill, Scott Nowson, and Jon Oberlander, preprint submitted to JCMC October 2006, which is hereby incorporated by reference in its entirety herein.

For any or all of the embodiments cited above, the method can be combined, correlated or otherwise linked to what people are saying, doing, hearing, or seeing (in cases of visual stimuli, such as visuals aids in the courtroom) in relation to what kind of emoting accompanies the statements, behavior or exposure to stimuli. Moreover, the opportunity to systematically and scientifically observe, and quantify the emotional dimension of people for the purpose of adding emotional data non-invasively allows for getting beyond unreliable verbal statements or responses alone. As such, the methods herein may possess several advantages, including but not limited to: (1) avoiding the risk that a person will, for instance, underreport consciously or subconsciously the degree to which they're not engaged by what the job entails, or that a negative trait like neuroticism applies to that person or over-report the degree to which a positive trait like agreeableness pertains to that person, for instance; (2) avoiding the additional expense and hassle of seeking to secure additional personality trait test results from people familiar with the person for the purpose of gaining greater reliability; (3) allowing for gathering emotional as opposed to rationally-oriented, cognitively filtered data as facial coding is geared to accessing and quantifying the emotional dimension; (4) in instances where the person is enacting a scenario, using facial coding to capture trait-related data allows for behavioral results as opposed to written or verbal input; (5) providing an extra dimension to the analysis of witnesses or the reactions of mock juries, over and above what people will acknowledge or knowingly reveal; (6) creating demographic segmentation profiles, and resulting strategies, to facilitate a better ability to develop and disseminate marketing materials that will suit the buyer attitudes, decision-making styles, and receptivity to the advertising styles/content of the target market; and/or (7) enabling the identifying of TV programming, for instance, that will be best suited to the target market, which may even, in some embodiments, extend to the point of understanding that the facial expressions and emotional dynamics of the stars of a given show, or an individual plot, certain action of themes, and/or scene within a plot, is most suitable for a given audience and/or the nature of the offer of a given potential sponsor, or even understanding that a given television spot, because its creative details, will register most optimally with a certain targeted segment.

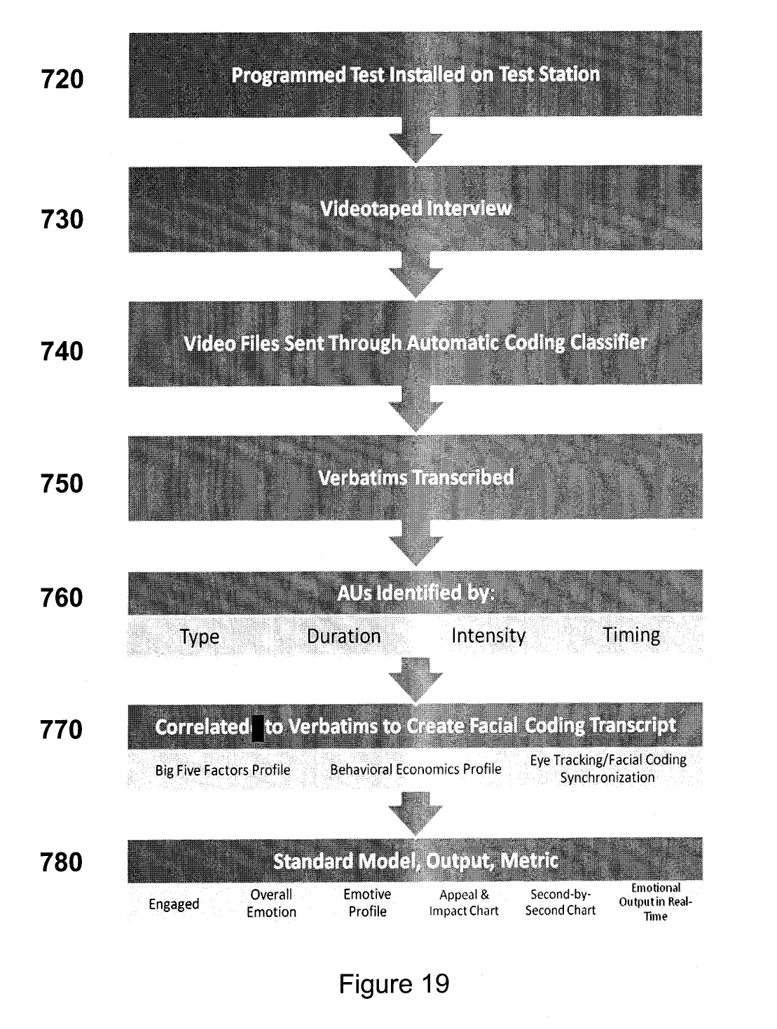

More specifically, according to various embodiments of the present disclosure, a system can be implemented to at least partly automate the above-described methods. A flowchart of one embodiment of such a system is outlined in FIG. 19, and may include one or more of the following: programming the test station 720; interviewing the subject and recording the interview 730; automatically coding the video 740; transcribing the verbatims 750; identifying the AUs by type, duration, intensity, and/or timing 760, for example; correlating the AUs to verbatims to create a facial coding transcript 770 that may include a Big Five Factor profile, behavioral economics profile, and/or eye tracking/facial coding synchronization, for example; and developing a statistical model, output, metric, etc. 780 that may include, for example, output relating to the extent to which the subject(s) is engaged, overall emotion of the subject(s), the emotive profile of the subject(s), appeal and impact charts for the subject(s), second by second charts, and/or emotional output in real time.

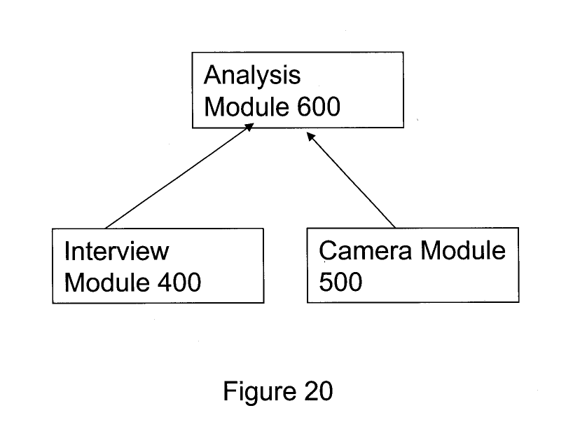

FIG. 20 shows the components of one embodiment of an automated system for implementing the various methods of the present disclosure. The automated system may include one or more of an interview module 400, a camera module 500, and an analysis module 600.

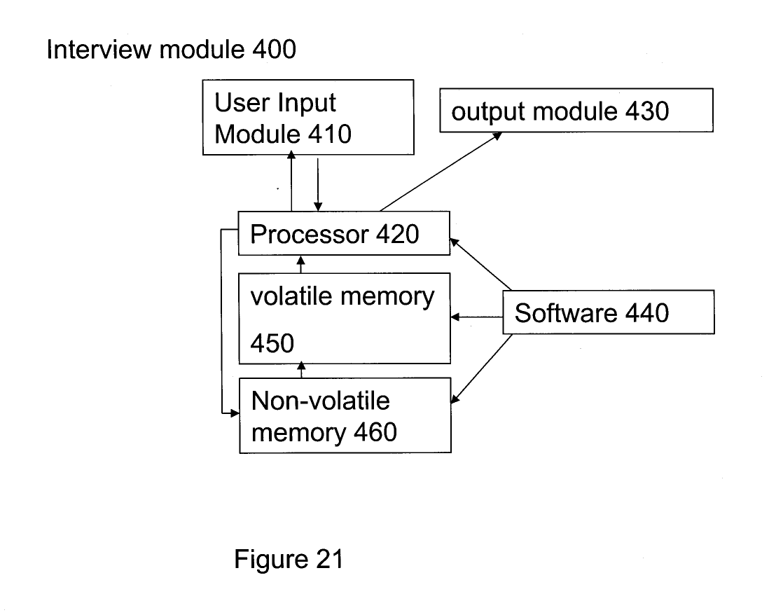

The interview module 400, as shown in FIG. 21 can be an interview computer system including a user input module 410, an output module 430, a processor 420, temporary volatile memory such as RAM 450, nonvolatile storage memory 460, and computer software 440. The user input module 410 can be a keyboard, a touch screen, vocal commands and responses, or any other method of interfacing with the computer system. The output module 430 could be a computer monitor, a projector, computer speakers, or any way of communicating to the subject of the interview. The processor 420 can be any general purpose or specialized computer processor such as those commercially available. The temporary volatile memory 450 can be any memory capable of or configured for storing code and/or executable computer instructions and data variables in memory. The nonvolatile storage memory 460 can be any memory capable of, or configured for storing computer instructions, either executable or non-executable, in object form or source code in non-volatile storage such as a hard drive, compact disc, or any other form of non-volatile storage. The computer software 440 can be specially developed for the purpose of interviewing the subject and/or capturing the video, or can be internet based, and delivered through third party browser applications.

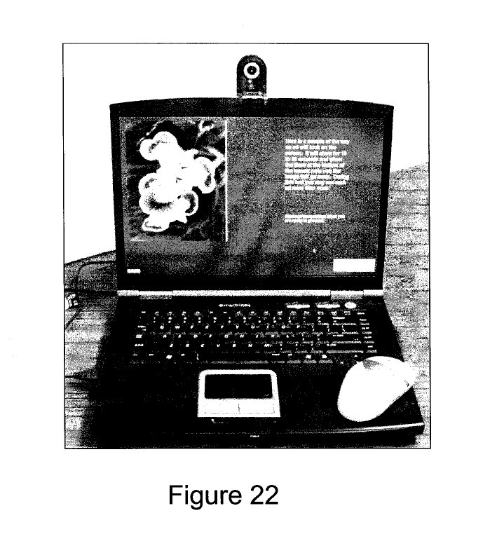

A camera module 500 can be any device or hardware and software for capturing video of the subject during the stimulus and can include a camera, such as, but not limited to a web cam such as the setup depicted in FIG. 22, or a camera placed in surveillance mode, or any other suitable camera setup including a professional camera setup. In some embodiments, the video footage may allow for the viewing of at least two-thirds of the person's face, since some facial expressions are unilateral, not be so far away as to preclude seeing specific facial features with enough clarity to evaluate facial muscle activity, and not be obscured by the person hiding or otherwise obscuring their face with their hands, a coffee cup, etc. or by moving with such rapidity as to blur the video imagery. FIG. 22 shows how a web cam or video camera mounted on a personal computer, built into a personal computer, or elsewhere deployed in a room can capture video images of a person or persons as they are speaking, hearing, or seeing oral or written presentations of statements, or otherwise engaged in behavior, in order to capture their facial expressions in response to the stimuli, situation, or environment. The camera module 500 can be operably and/or electronically connected to the interview module and/or the analysis module 600.

In one embodiment, the process may begin by developing the question or questions, enactment scenarios, general statements, performance situation, appearance on television, internet, or mobile device programming, or other format that might be desirable for capturing video files or observational notes in order to gauge the person in question. The format to be enacted can be made easier to enact on a standard, repeatable basis without operator error by using computer software to ensure that the format involves every element (question/scenario, etc.) in either a set order sequence or an order that is intentionally randomized. This software could first be programmed onto the test station computer via software 440. This can be a specialized application, an internet based application, or other suitable type of software. The questions or other elements of the format, including instructions, can either be shown on screen or verbalized using a played audio file via output module 430 to deliver each step in the process of gaining data from the person in question. Typically, a suitable response interval can be set for a duration of 30 seconds to 2 minutes in length. A scenario, for example, can suitably run for 2 to 5 minutes, or any other desirable amount of time.

Once the interview module and the camera module are setup, then the videotaped interview or format for gathering input can commence. The interview session may be recorded by the camera module 500 which can be setup to ensure high quality images of the participant's facial expression as obtained throughout the session. The person can be instructed, for example, to (i) look into the camera (ii) avoid any extreme or radical head movement during the session and (iii) keep from touching their face during the session. A reasonably close up filming can be used, including one in which the person's face is at least ¾ths visible as opposed to a profile filming positioning. Both the oral statements (audio) and the facial expressions (video) can be captured by the camera for the purposes of subsequent review, or the video files alone can be solely captured for the purposes of the analysis to be performed.

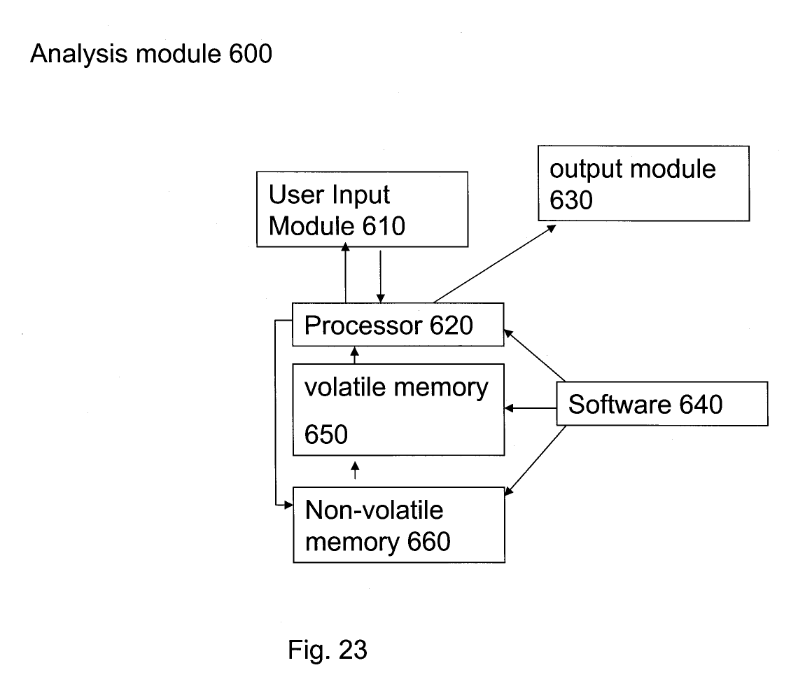

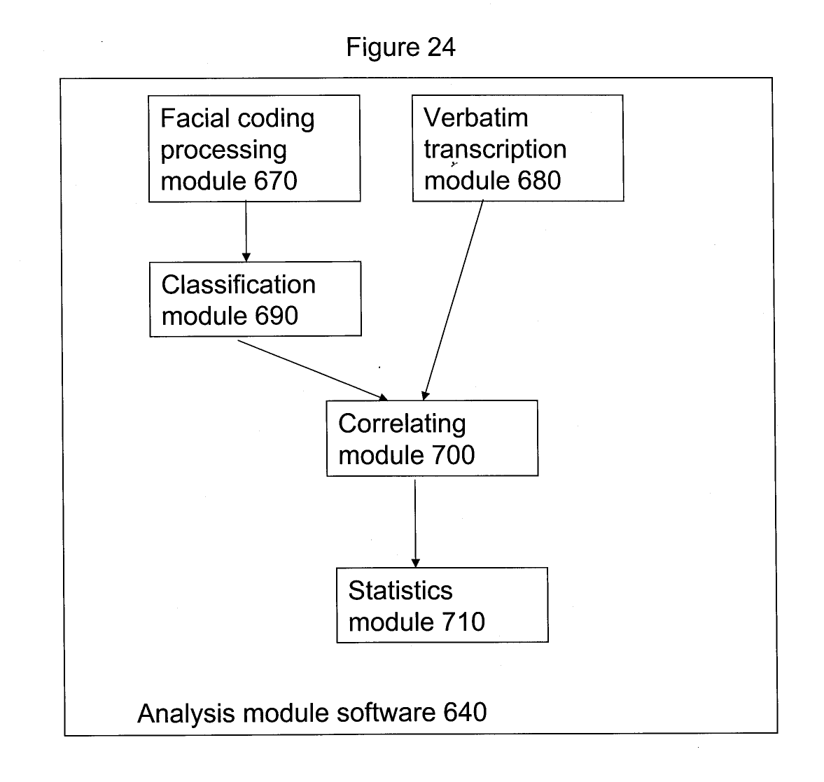

After the interview is over, the data collected can be sent to the analysis module 600. The analysis module, as shown in FIG. 23, can be a computer system including a user input module 610, an output module 630, a processor 620, temporary volatile memory 650 such as RAM, nonvolatile storage memory 660, and computer software 640. The user input module 610 can be a keyboard, a touch screen, vocal commands and responses, or any other method of interfacing with the computer system. The output module 630 could be a computer monitor, a projector, computer speakers, or any way of communicating to the subject of the interview. The processor 620 can be any general purpose computer processor such as those commercially available. The temporary volatile memory 650 can be any memory capable of, or configured for storing code and/or executable computer instructions and data variables in memory. The nonvolatile storage memory 660 can be any memory capable of, or configured for storing computer instructions, either executable or non-executable, in object form or source code in non-volatile storage such as a hard drive, compact disc, or any other form of non-volatile storage. The computer software 640 can be specially developed for the purpose of analyzing the data, or can be based on third party applications. The computer software as shown in FIG. 24 can include one or more of a facial coding processing module 670, a verbatim transcription module 680, a classification module 690, a correlating module 700, and a statistical module 710.

The facial coding processing module 670 that could be utilized herein can be hardware and/or software that is configured to read the facial muscle activity, AUs, and/or general expressions of people based on the repetitious refinement of algorithms trained to detect the action units that correspond to emotions in FACS or through any other method of analyzing and scoring facial expressions. To do so, the processing module can take into account the movement of facial muscles in terms of a changed alignment of facial features, plotting the distance between the nose and mouth, for instance, such that when an uplifted mouth may, for example, signal disgust, the distance between the nose and mouth is reduced and the presence of an AU 10, disgust display, is documented, including potentially the duration of the expression, its intensity, and the specific time element that denotes when the expression hit its emotional high-point or peak. Likewise, the processing module can be configured to do all of the various computations described in the preceding paragraphs.

The facial coding processing module 670 may include software modules, such as but not limited to, software under development by ReallaeR, for instance, where FACS is concerned, or if for general facial muscle activity, perhaps defined as “motion units,” then as available from VicarVision or Noldus, or a combination thereof or however else derived, including but not limited to, from such firms as Nviso, Affedctiva, General Electric, the Fraunhofer Institute, etc. A range of other coding system for facial muscle activity might likewise be in various stages of development from universities such as the University of California, San Diego (UCSD), MIT, Carnegie Mellon, the University of Pittsburgh, alone or in collaboration between sets of academics and/or their business or governmental sponsors. Generally, the processing module 670 may involve the assistance of a computerized program with software that reads a person or group's facial expressions automatically. Over time, the algorithms on which the analysis is based will derive results such that a database can be built up to reflect which types of emotional responses fit various outcomes, like greater likelihood to be a good romantic partner, a productive employee, a manager or executive highly skilled at exhibiting emotional intelligence in interacting with others, etc.

With the advent of such systems as described herein, it might also be more feasible to serve target markets like doctors and psychologists aiming to aid those who struggle with alcohol addiction, depression, and other forms of psychopathology or in police detection work, man-machine communication, healthcare, security, education, remote surveillance, and telecommunications. Additionally, video files can be reviewed and analyzed for credibility, emotive displays, etc., as submitted by individuals through social internet networking sites where people want to gain credible assessments of others or of situations and behaviors. Further, such systems as described herein can facilitate the task of facial action detection of spontaneous facial expressions in real-time. Such systems can recognize which muscles are moved, and the dynamics of the movement. Machine learning methods, like support vector machines and AdaBoost, for example, can be used to aid texture-based image representations. Machine learning methods applied to the related problem of classifying expressions of basic emotions can likewise involve linear discriminant analysis, feature selection techniques, Gabor filters, and other such tools as may be developed and/or prove relevant to the process. Image-based presentations that account for image texture can also be used. Such software can also take into account speech related mouth and face movements, and in-plane and in-depth movements by the subject being coded. Moreover, such software could be adept in considering how blends of multiple action units happening simultaneously or in overlapping timeframes cause a given AU to adopt a somewhat different appearance.

A manual or automatic transcription of the verbatims from the answers given during the interview can be created by the verbatim transcription module 680. The analysis module can either automatically create the transcript using speech recognition software, or the manual transcription can be entered into the module via the user input module, or sent to, or otherwise transferred to the analysis module.

The automated software's classification module 690 can then be deployed to identify one or more of the type, duration, intensity, and specific timeframe for each AU or other facial muscle expression shown by a given person. The captured video can for facial coding purposes be analyzed on a second-by-second basis, e.g., 30 frames per second, to identify the action units or other types of facial expressions that will become the basis for the analysis. Those action units can be accumulated per person, or group, in relation to a given question, statement, stimulus or scenario being enacted. Those results can, if desirable, then be correlated according to the methods described above to, for example, the completed verbatim transcription by the correlation module 700.

The correlation module 700 can be any automated, or computer assisted means of correlating the results of the classifier 690 with the verbatim transcriptions. The correlation could also be done manually.

The statistical module 710 can then work from pre-established algorithms, as described above, to derive the statistical output, such as that related to engagement, overall emotion (including by topic), emotional profile, appeal and impact chart, second-by-second chart, and/or emotional displays in real-time, for example. Moreover, in some embodiments, this step can include deriving a Big Five Factor model personality type data, a Behavioral Economics profile, and/or eye tracking and facial coding synchronized results. Moreover, in reviewing the linkages between verbatims and facial coding data, and even the nature or characteristics of the emotional displays, examination can be done to identify the topics that elicited what types of emotion, where emotion was absent, when the emotion seemed more posed or genuinely felt, where veracity is suspect, and the like. The output may then be displayed on by the output module 630, or sent to any other system or printed, or otherwise delivered in a suitable manner.

One embodiment of the present disclosure could involve a number of elements described as follows and outlined in FIG. 19 as well. A subject's emotional percent-ranks may be compared to ideal ranks. To identify the percentage at which the subject matches up to the Big Five personality traits, the following formula can thus be used:

Trait Correlation=sum of|(emotional percent-rank−optimal percent-rank)|/Sum of perfect correlations

For example:

Conscientiousness=|(surprise % rank−1)|+|(frustration % rank−1)|/(Perfect correlation surprise(1)+perfect correlation frustration(1))

In such embodiment, a value of zero (0) can indicate that the subject has a perfect emotional correlation to the Big Five Trait. A value X<0.33333 can indicate a high correlation, 0.33333<X<0.66667 can indicate a medium correlation, and X>0.66667 can indicate a low correlation. The above formula is but one correlation formula, and other formulas, as well as other correlation designations, may be defined and/or used, and are within the spirit and scope of the present disclosure.

### EXAMPLES

For example, a company can use one embodiment of the method to better fill a sales position. Five people have applied, for example, and each of the applicants can be asked to take an IQ test, an unstructured interview with the director of sales, but also a structured interview format in which facial coding will be used to capture the EQ (emotional intelligence) and other dimensions of the job applicants to get a better read on their ability to handle the job. Because being an effective salesperson can involve qualities essential to success, such as but not limited to—1) resiliency (to accept hearing “no” from prospects and keep on going—2) optimism (to be upbeat and thus come across as confident and able to put the prospect at ease, and—3) empathy, so as to create a win/win scenario in negotiations—the format of the interview can consist of, for example, one or more questions related to each of those traits and one or more questions each related to each of the Big Five Factor model personality traits, for a total of 8 or more questions to be videotaped for review. In each case, the job applicant can be given 30 seconds, or some other reasonable period of time to respond, with both the audio and video to be reviewed and analyzed. In addition, a 3-minute cold-call phone call scenario can be enacted by the job applicant, and videotaped for facial coding purposes, including, for example, one or more posed “objections” by the supposed receiver of the call, with the objections appearing on the display screen during the simulated cold call scenario. Afterwards, in accordance with this embodiment of the method, all 30-second question files and the 3-minute scenario can have the transcript analyzed, the video files facially coded, and the results tabulated. As a result of formulas involving the 10 emotional states shown earlier in the emotional profile, such as for instance sadness being incompatible with resiliency, or fear being indicative of neuroticism, for instance, statistical metrics can be produced indicating the job applicant's raw scores, comparisons against the norms for sales people, and the degree of fit for the job. For instance, previous research suggests that a good sales person will be extraverted, so that personality trait should be robust as identified by not only a written exam assessment of personality type, based on, for example, a 10-question written format rating system, but also as verified and explored through the facial coding findings.

In another embodiment, an interne dating service can have each new participant in the dating service take a self-assessment test or profile that will now include a video of their responses to select questions as well as in making a general introductory statement about themselves. Again, one or more questions can be asked to relate to each of the Big Five Factor model personality traits, with the general introductory statement potentially limited to, for example, 3 minutes, or some other suitable response time. These answers and the three minute introduction can then be reviewed in terms of facial coding results to identify the personality type of the individual, their overall level of engagement while making the introductory statement, the types of emotions they display during the video files, etc. That information can then available to members of the dating service who want to locate a person most suitable for them to date as a possible romantic partner. In a further embodiment of this example, a person who has then identified a limited range of people as potential partners may, for a fee, arrange for the service to ask additional questions related to values, attitudes, hobbies, etc., whereby the potential partner then records additional answers that will get videotaped, analyzed, and shared on a reporting basis with the dating service member who made the request. In that way, the dating service member can, for example, learn whether, for instance, the potential partner truly shares their enthusiasm for a given hobby, etc.

In another embodiment, a professional, such as a lawyer or psychiatrist can have a videotaped interview or deposition analyzed for the purposes of diagnosing their veracity, emotional state, types of motivations, etc. Such facial coding analysis alone or in conjunction with, for example, the transcribed comments can reveal what the witness, jury prospect, depressed client, etc., said, and how they felt while talking. Topics where there is a large degree of emoting, or emoting that might be incongruous with the statements made, can for example be flagged, suggesting that legal counsel or a psychologist might want to explore these aspects of the person's statement in greater depth because of incongruities between emotions felt and stated, the detection of potentially posed emotions, the absence or abundance of emotions related to a given topic, and so forth. In these cases, the video file may not have a set number of questions to be replied to, or timing elements. Instead, the video files can be captured for lengths of time ranging from, for example five minutes to an hour or more, with the possibility that in requesting facial coding analysis the lawyer or psychologist can identify certain time periods or topics from the transcript that should be explored, while omitting other videotaped material for reasons related to costs or turn-around time on the analysis. One advantage of securing facial coding analysis for a litigation attorney, for instance, may be that a videotaped deposition can be analyzed such that lines of inquiry that netted a high volume of emotional engagement, or negative emotions, for instance, such as fear, can indicate a place where greater scrutiny is called for because a key aspect of the case may have been inadvertently identified or else it may become evident that the person may not have revealed everything he or she knows about the matter subject to litigation, criminal investigation, etc. Meanwhile, for a mock jury facial coding analysis can prove of benefit in determining what lines of argumentation will resonate with, and convince, the actual jury in the case when presented in court.

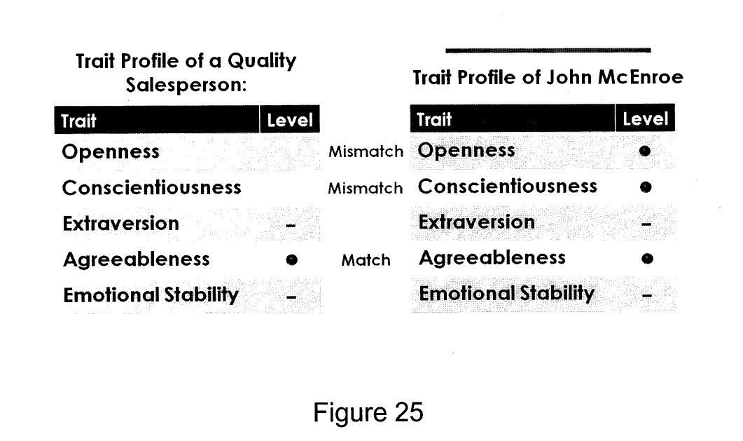

In still another embodiment, in choosing casting talent to connect with the target market, taking into account personality traits can be valuable. On the left in FIG. 25 is the Big Five personality traits that might be most suitable for quality salespeople. On the right is a projected personality profile for tennis star/spokesperson, John McEnroe. In the instance at hand—a television commercial for a car rental service—the television spot showed McEnroe dressed in a suit and he was not shown with a girlfriend or family. It might be possible to infer that the television spot's intended audience is businesspeople, including a heavy mix of salespeople who travel frequently and need a rental car. Unfortunately for the car rental service, McEnroe's personality type doesn't match in two of three cases, i.e., in regards to Openness and Conscientiousness, what a typical good salesperson would embody. This mismatch can arguably be said to show that the car rental television spot won't connect with the target market in optimal fashion.

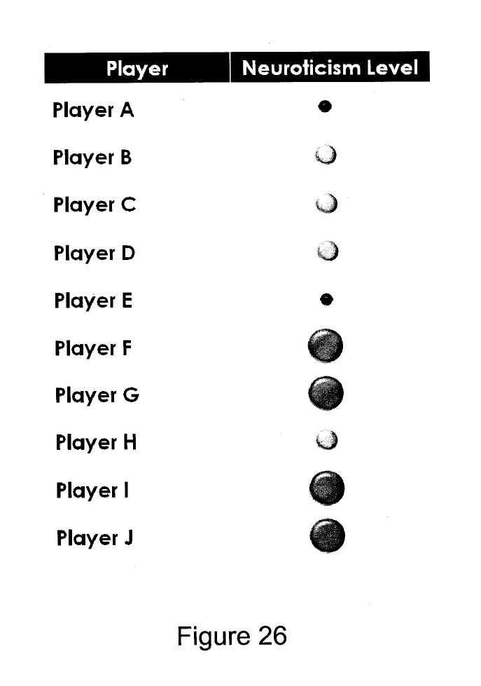

In another embodiment, taken from professional sports, a NBA team may be observed at court-side for one or more games in order to take observational notes regarding how the various players emote during game performance, as well as on the bench in interacting with other players and coaches. The example in FIG. 26 shows a portion of the team's roster and how the emoting reveals a team that struggles with handling stress well, i.e. suffers from neuroticism, which manifests itself in turn in having a high turn-over rate, losing the ball from passes and during dribbling the basketball, in games.

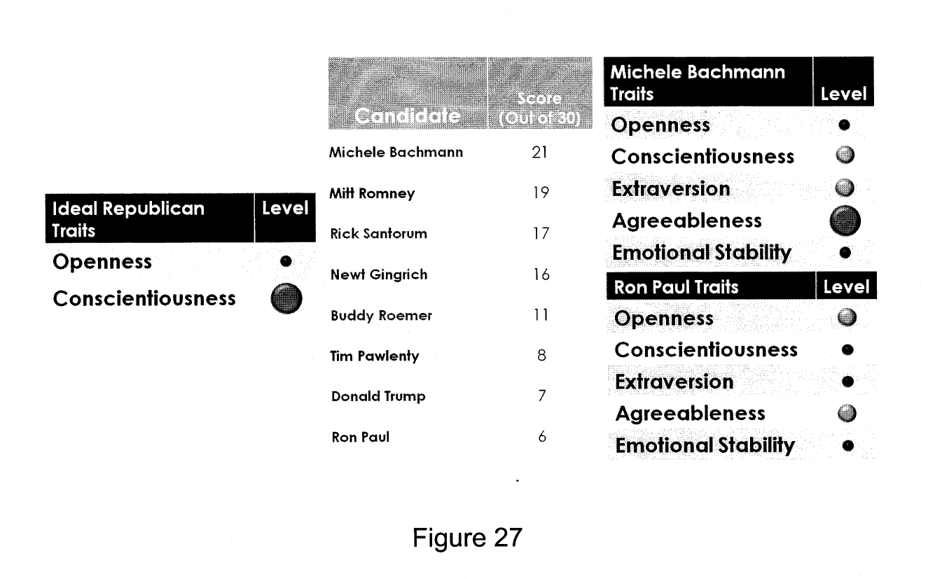

Yet another embodiment illustrates the likely personality trait of GOP voters and how, emoting style as revealed through the facial coding of one or more speeches, for example, may reveal whether that politician's emoting style and subsequent personality traits profile makes the candidate a good or poor fit to match up with the party's members. In FIG. 27, the far left chart illustrates typical traits representative of republican voters. The middle chart ranks the presidential candidates according to their correlation to the typical traits representative of republican voters. The far right charts identify the Big Five Model trait profile of two of the candidates.

As yet another example embodiment, reality programming can be enhanced for viewers by having explicitly shown, in some cases by a simple label or other indicator, the emotion, dominant emotion, and/or blend of emotions a participant may show at a given moment in time. Such displays of the emotions felt by people in television or other media programming could also run as a real-time graphic in conjunction with the imagery on screen, as an opt-in feature for instance.

In the foregoing description, various embodiments of the disclosure have been presented for the purpose of illustration and description. They are not intended to be exhaustive or to limit the disclosure to the precise form disclosed. Obvious modifications or variations are possible in light of the above teachings. The embodiments were chosen and described to provide the best illustration of the principals of the disclosure and its practical application, and to enable one of ordinary skill in the art to utilize the various embodiments with various modifications as are suited to the particular use contemplated. All such modifications and variations are within the scope of the disclosure as determined by the appended claims when interpreted in accordance with the breadth they are fairly, legally, and equitably entitled.

1. A method of assessing an individual through facial muscle activity and expressions, the method comprising:
(a) receiving a visual recording stored on a computer-readable medium of an individual's non-verbal responses to a stimulus, the non-verbal response comprising facial expressions of the individual, so as to generate a chronological sequence of recorded verbal responses and corresponding facial images;
(b) accessing the computer-readable medium for detecting and recording expressional repositioning of each of a plurality of selected facial features by conducting a computerized comparison of the facial position of each selected facial feature through sequential facial images;
(c) coding contemporaneously detected and recorded expressional repositionings to at least one of an action unit, a combination of action units, or at least one emotion; and
(d) analyzing the at least one of an action unit, a combination of action units, or at least one emotion to assess one or more characteristics of the individual to develop a profile of the individual's personality in relation to the objective for which the individual is being assessed.

2. The method of claim 1, wherein the visual recording further comprises a verbal response to the stimulus, and wherein analyzing the at least one of an action unit, a combination of action units, or at least one emotion utilizes the verbal response comprises assessing the at least one emotion against at least portions of the individual's verbal response to assess one or more characteristics of the individual with respect to the individual's verbal response.

3. The method of claim 2, wherein the verbal responses are categorized by topic.

4. The method of claim 2, further comprising creating a transcript of at least a portion of the individual's verbal response, and analyzing the at least one of an action unit, a combination of action units, or at least one emotion comprises one or more of:
identifying places in the transcript of emotional response;
identifying the valence of the emotions for places in the transcript;
identifying one or more emotions that are most predominant with respect to at least portions of the transcript; and
identifying discrepancies between the verbal response and emotive response of the individual.

5. The method of claim 1, wherein detecting and recording facial expressional repositioning of each of a plurality of selected facial features comprises recording the timing of the detected repositioning for peak emoting and real-time duration.

6. The method of claim 1, wherein coding contemporaneously detected and recorded expressional repositionings comprises automatically coding a single action unit or combination of action units to at least one corresponding emotion by percentage or type.

7. The method of claim 1, wherein coding contemporaneously detected and recorded expressional repositionings comprises coding a single action unit or combination of action units to a weighted value.

8. The method of claim 1, wherein analyzing the at least one of an action unit, a combination of action units, or at least one emotion comprises determining whether the individual's emotional response is predominantly positive, neutral, or negative.

9. The method of claim 1, wherein analyzing the at least one of an action unit, a combination of action units, or at least one emotion comprises quantifying the volume of emotion to determine the degree to which the individual is engaged or enthusiastic.

10. The method of claim 5, wherein analyzing the at least one of an action unit, a combination of action units, or at least one emotion comprises quantifying the duration of each action unit or combination of action units to determine the degree to which the individual is engaged or enthusiastic.

11. The method of claim 1, wherein analyzing the at least one of an action unit, a combination of action units, or at least one emotion comprises analyzing the degree of intensity for each action unit or combination of action units to determine the degree to which the individual is engaged or enthusiastic.

12. The method of claim 1, wherein analyzing the at least one of an action unit, a combination of action units, or at least one emotion comprises identifying moments of the recording that elicited emotion based on the at least one of an action unit, a combination of action units, or at least one emotion.

13. The method of claim 1, wherein analyzing the at least one of an action unit, a combination of action units, or at least one emotion comprises developing a profile of the individual's personality based on the percentage of positive versus negative emotions and the specific emotions shown during the stimulus.

14. The method of claim 1, wherein analyzing the at least one of an action unit, a combination of action units, or at least one emotion comprises corresponding the at least one of an action unit, a combination of action units, or at least one emotion by stimulus type to relate emotional response data for the individual to a formula for determining the degree to which the individual fits one or more of the Big Five Factor model personality traits.

15. The method of claim 1, wherein analyzing the at least one of an action unit, a combination of action units, or at least one emotion comprises corresponding the at least one of an action unit, a combination of action units, or at least one emotion by stimulus type for determining the degree to which the individual is susceptible to one or more of the biases identified as part of Behavioral Economics.

16. The method of claim 1, wherein the stimulus comprises one or more of questions, statements, or scenarios.

17. The method of claim 16, wherein the objective the individual is being assessed for is the individual's suitability for a job position or task related to a job.

18. The method of claim 16, wherein the objective the individual is being assessed for is to determine potential romantic partners.

19. The method of claim 16, wherein the objective the individual is being assessed for is to ascertain one or more of emotional responses, potential veracity, personality type, and levels of enthusiasm for legal applications.

20. The method of claim 1, further comprising linking eye tracking data from the visual recording with the at least one of an action unit, a combination of action units, or at least one emotion.

21. (canceled)

22. (canceled)

23. (canceled)
